(19) United States
(12) Patent Application Publication
(10) Pub. No.: US 2026/0102910 A1
(43) Pub. Date: Apr. 16, 2026

(54) LEARNING MANIPULATION THROUGH JACOBIAN MATRIX OF STIFFNESS AND IMPEDANCE CONTROL

(71) Applicant: Devol Robots Sdn. Bhd., Petaling Jaya (MY)

(72) Inventors: Yi Herng Ong, Ulu Tiram (MY); Sze Yuan Cheong, Johor Bahru (MY)

(73) Assignee: Devol Robots Sdn. Bhd., Petaling Jaya (MY)

(21) Appl. No.: 19/355,671

(22) Filed: Oct. 10, 2025

Related U.S. Application Data
(60) Provisional application No. 63/706,002, filed on Oct. 10, 2024.
(60) Provisional application No. 63/706,003, filed on Oct. 10, 2024.

(51) Int. Cl. B25J 9/16; B25J 13/08; B25J 19/02

(52) U.S. Cl. CPC B25J 9/163; B25J 9/1607; B25J 9/161; B25J 9/1653; B25J 13/085; B25J 19/023

(57) ABSTRACT

The present disclosure provides a method of learning physical interactions in robotic manipulation, comprising formulating a learning representation that includes a spatial force of a robotic manipulator, a spatial stiffness, and a spatial damping of the manipulator, wherein the learning representation is used by an artificial intelligence agent to interpret or learn the dynamic interaction between the robotic manipulator and an object or environment. The spatial stiffness and spatial damping are derived from joint-space stiffness and damping parameters using Jacobian-based transformations. The learning representation may be provided in forms comprising spatial force vectors, stiffness matrices, damping matrices, end effector pose data, gripper force measurements, and vision sensor data. The representation serves as input to artificial intelligence learning algorithms including reinforcement learning, supervised learning, or imitation learning, enabling the agent to learn control policies for manipulating objects or regulating contact forces.

### CROSS-REFERENCE TO RELATED APPLICATIONS

This application claims priority to U.S. Application No. 63/706,003, titled LEARNING MANIPULATION THROUGH JACOBIAN MATRIX OF STIFFNESS AND IMPEDENCE CONTROL, filed Oct. 10, 2024, and U.S. Application No. 63/706,002, titled EMBEDDED SYSTEM DESIGN AND CONTROL, filed Oct. 10, 2024, which are hereby incorporated by reference in its entirety.

### FIELD OF INVENTION

The present disclosure relates to robotics and artificial intelligence systems, and more particularly to learning representations for robotic manipulation that incorporate spatial impedance parameters derived through Jacobian matrix transformations to enable robots to interpret and respond to physical interactions with objects and environments.

### BACKGROUND

Robotic manipulation has emerged as a fundamental challenge in the field of robotics, requiring systems to interact physically with objects and environments in a controlled and adaptive manner. Traditional robotic control approaches often rely on rigid position-based control strategies that can lead to instability or damage when unexpected contact forces arise during manipulation tasks. This has led to the development of impedance control frameworks, which allow robots to exhibit compliant behavior by modulating their stiffness and damping characteristics in response to environmental interactions.

Impedance control enables robots to behave like virtual spring-damper systems, where the relationship between applied forces and resulting motions can be precisely regulated. In conventional impedance control, stiffness and damping parameters are typically set manually by expert operators based on task requirements and environmental conditions. However, this approach becomes increasingly challenging as manipulation tasks grow in complexity and variability, particularly when robots must adapt to changing environmental conditions or handle diverse objects with different physical properties. The new learning representation builds on embodied AI concepts by providing a more efficient and adaptive framework for how embodied AI systems learn from their environments, addressing the gap in understanding the physical context, dynamic constraints, and the intricacies of robot-environment interaction that are essential for executing complex commands.

The integration of artificial intelligence and machine learning techniques with robotic control systems has opened new possibilities for adaptive manipulation strategies. Modern AI approaches, including reinforcement learning and deep learning, have demonstrated remarkable capabilities in learning complex behaviors from experience. However, existing learning frameworks for robotic manipulation often operate on low-level sensor data or simplified state representations that do not explicitly capture the underlying physical interaction dynamics between the robot and its environment. Current generative AI demonstrates impressive capabilities in learning sequential and contextual data, but falls short in establishing a direct, functional relationship between robotic control and physical objects within the working environment, struggling to interpret nuanced human instructions and translate them into precise, real-world actions necessary to be performed by the robotic systems.

Current AI-driven robotic systems face challenges in bridging the gap between high-level decision making and the physical realities of contact-rich manipulation tasks. Many learning approaches treat the robot-environment interaction as a black box, making it difficult for AI agents to develop intuitive understanding of how changes in control parameters affect physical outcomes. This limitation becomes particularly apparent in tasks requiring nuanced force control, such as assembly operations, delicate object handling, or human-robot collaboration scenarios.

The field of embodied artificial intelligence seeks to address these challenges by developing AI systems that can effectively reason about and learn from physical interactions. However, existing approaches often lack structured representations that capture the relationship between control parameters and physical behavior in a way that facilitates efficient learning and generalization across different manipulation contexts.

Human operators naturally adjust their compliance and force application strategies based on tactile feedback and visual cues when performing manipulation tasks. Translating this intuitive understanding of physical interaction dynamics into AI-driven robotic systems remains an ongoing challenge in the robotics community. There exists a need for learning representations that can effectively encode the relationship between impedance parameters, applied forces, and environmental interactions in a manner that enables AI systems to develop sophisticated manipulation strategies through experience.

Robotic manipulation in unstructured environments requires understanding both visual context and physical interaction cues. Impedance control is a well-known strategy in robotics for safe and adaptive interaction, where a robot regulates its apparent stiffness, damping, and force output when contacting objects.

Traditional robot learning approaches, however, often rely solely on vision or kinematics and lack a unified representation of physical contact dynamics. This gap makes it challenging for robots to anticipate outcomes of actions that involve forces (e.g., pushing, gripping, or inserting objects) and to adapt to variations in object properties or contact conditions. While the above representation advanced the state of the art in reinforcement learning and robot control, the prior patents focused on using it for reactive control and reward-driven learning. However, they did not explicitly address using fused impedance-and-vision representation in a predictive model to forecast future states or dynamics. In the field of self-supervised learning, recent developments (e.g., joint embedding predictive architectures for images and videos) have shown that predicting abstract representations of future observations can yield efficient world models of the environment. These models (such as the Joint Embedding Predictive Architecture (JEPA) and its visual variant V-JEPA) learn to predict the latent representation of missing or future portions of data instead of raw sensory outputs. Such approaches are computationally efficient and capture high-level dynamics without needing to generate pixel-level predictions.

Specifically, existing predictive learning frameworks have largely been limited to visual data (and occasionally proprioceptive states) and have not incorporated rich physical interaction data like forces or impedance parameters. For instance, world models for robotics often rely on vision alone to predict future images or states, which makes it difficult to capture contact physics or object properties that aren't directly visible. This limitation means a robot may not foresee events like an object slipping from its grip or the effect of stiff contact, because these require understanding the force dynamics, not just vision.

Accordingly, there is a need for an improved system that builds upon the previously defined impedance-based representation and integrates it into a predictive, self-supervised learning model. By doing so, the robot can learn a physics-aware world model: it can internally simulate or predict the outcome of interactions (e.g., “if I push harder, the object will move this way, and forces will change that way”) without explicit programming. Moreover, adding physical force/stiffness data to visual prediction can enable more robust sim-to-real transfer, since the model learns fundamental physical relations that hold across simulation and real environments (unlike raw pixels that may differ). The present disclosure addresses these needs by introducing a predictive learning architecture that fuses vision with impedance-based data, along with a novel training objective to ensure the learned dynamics are smooth and physically plausible.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of learning physical interactions in robotic manipulation is provided. The method includes formulating a learning representation that includes a spatial force of a robotic manipulator, a spatial stiffness, and a spatial damping of the manipulator. The method includes deriving the spatial stiffness and the spatial damping from joint-space stiffness and damping parameters using a Jacobian-based transformation. The method includes providing the learning representation as an input state to an artificial intelligence learning algorithm, wherein the artificial intelligence learning algorithm uses the learning representation to learn a control policy for manipulating objects or regulating contact forces.

According to other aspects of the present disclosure, the method may include one or more of the following features. The learning representation may be provided in a first form comprising a six-dimensional spatial force vector including forces and moments, a spatial stiffness matrix, a spatial damping matrix, an end effector pose, a gripper force measurement, and vision sensor data. The learning representation may be provided in a second form comprising N-degrees of freedom of joint torque, a Jacobian matrix of the robotic manipulator, a joint-space stiffness matrix, a joint-space damping matrix, joint angles, a gripper force measurement, and vision sensor data. The spatial stiffness Kₓ may be defined as Kₓ=J(q)^{-T} K_{Q}J(q)⁻¹ and the spatial damping Dₓ may be defined as Dₓ=J(q)^{-T}D_{Q}J(q)⁻¹, where J is a Jacobian matrix of the robotic manipulator (it can be the body Jacobian or space Jacobian of the manipulator depending on the reference frame), K_{Q} is a joint-space stiffness matrix, and D_{Q} is a joint-space damping matrix. The vision sensor data may comprise RGB images captured by cameras observing the robotic manipulator's workspace. The vision sensor data may further comprise depth maps providing three-dimensional spatial information about objects in the robotic manipulator's environment. The method may further comprise controlling the robotic manipulator using an impedance-based control law that incorporates the learned control policy, wherein a commanded end-effector force is computed as a sum of a guidance force provided by the artificial intelligence learning algorithm, a reactive force term from the spatial stiffness matrix multiplied by an end-effector position error, a reactive force term from the spatial damping matrix multiplied by an end-effector velocity error, and compensation forces for gravity and Coriolis effects, such that the guidance force is generated by the artificial intelligence learning algorithm based on learned manipulation strategies for specific task contexts. The robotic manipulator may comprise one or more series elastic actuators at its joints, each series elastic actuator having an elastic element with flexible spokes and a sensor for measuring deflection of the elastic element, and wherein joint torque values derived from the measured deflection are included in the learning representation as part of the spatial force or as joint-level force feedback.

According to another aspect of the present disclosure, a robotic system is provided. The robotic system includes a robotic manipulator with multiple degrees of freedom. The robotic system includes one or more sensors configured to measure forces at an end effector of the manipulator and to capture visual data of the manipulator's environment. The robotic system includes a control unit comprising a processor configured to execute an artificial intelligence agent, wherein the control unit is programmed to formulate a learning representation including spatial force, spatial stiffness, and spatial damping information from the manipulator and to adjust control commands to the manipulator based on said representation, such that the system learns to manipulate objects through physical interaction by adapting stiffness, damping, and applied forces in response to sensor inputs.

According to other aspects of the present disclosure, the robotic system may include one or more of the following features. The one or more sensors may comprise any of a six-axis force-torque sensor mounted at a wrist of the robotic manipulator for measuring the spatial force and a gripper force sensor configured to measure forces applied by an end effector gripper of the robotic manipulator. The control unit may be programmed to derive the spatial stiffness and spatial damping from joint-space stiffness and damping parameters using Jacobian-based transformations. The spatial stiffness Kₓ may be computed as Kₓ=J(q)^{-T}K_{Q}J(q)⁻¹ and the spatial damping Dₓ may be computed as Dₓ=J(q)^{-T}D_{Q}J(q)⁻¹,where J is a Jacobian matrix of the robotic manipulator, K_{Q} is a joint-space stiffness matrix, and D_{Q} is a joint-space damping matrix. The artificial intelligence agent may be configured to execute a reinforcement learning algorithm that uses the learning representation as a state input and generates actions that modify impedance parameters of the robotic manipulator. The one or more sensors may correspond to one or more actuators, and wherein the processor controls the one or more actuators based on torque measurements from the one or more sensors. The AI agent may comprise a plurality of artificial intelligence agents, wherein each artificial intelligence agent of the plurality of artificial intelligence agents is hosted by an individual processor located in each robotic actuator of the one or more robotic actuators, and wherein each artificial intelligence agent of the plurality of artificial intelligence agents collects a respective data set. Each artificial intelligence agent of the plurality of artificial intelligence agents may be in communication with a central processor, wherein each artificial intelligence agent of the plurality of artificial intelligence agents transmit their respective data sets to the central processor.

According to another aspect of the present disclosure, a method of controlling a robotic manipulator using impedance-based learning is provided. The method includes generating a spatial force field via a learning model that processes impedance-based learning representation data including spatial force vectors, spatial stiffness matrices, and spatial damping matrices. The method includes constructing a Jacobian representation of a force vector using the spatial force field and spatial force vector. The method includes training an artificial intelligence agent based on the Jacobian representation using reinforcement learning, supervised learning, or imitation learning. The method includes continuously updating the Jacobian representation based on real-time inputs from the robotic manipulator.

According to other aspects of the present disclosure, the method may include one or more of the following features. The impedance-based learning representation data may comprise a spatial force vector, a spatial stiffness matrix, a spatial damping matrix, an end effector pose, a gripper force measurement, and vision sensor data. The vision sensor data may comprise RGB images and depth maps captured by cameras observing the robotic manipulator's workspace. The artificial intelligence agent may be trained using a reinforcement learning algorithm that receives the Jacobian representation as a state input and generates actions that modify spatial stiffness and damping parameters of the robotic manipulator, and wherein initial data sets are derived from human demonstrations that include force sensor data from robotic actuation joints converted into Jacobian matrices of stiffness and damping and denoted as high rewards.

According to an aspect of the present disclosure, a method of learning physical interactions in robotic manipulation is provided. The method includes formulating receiving a multi-modal sensor data from a robotic system, wherein the multi-modal sensor data includes a visual data from a device, a spatial force of a robot's multi-linkage body, a spatial stiffness, a spatial damping, and a gripper force. The method includes formulating encoding and a fusion of the multi-modal sensor data into a unified latent representation of the system's state. The method includes formulating training a predictor network to predict a future latent representation of the system's state from a current latent representation. Lastly, the method includes formulating applying a temporal smoothness regularization term in a training cost function, wherein the temporal smoothness regularization term penalizes a rate of change of the future latent representation between consecutive time steps to encourage the predictor network to learn smooth and physically-plausible dynamics in its latent predictions.

According to other aspects of the present disclosure, the method may include a device obtaining visual data which may comprise a RGB camera, RGB-D camera.

According to other aspects of the present disclosure, the method may include spatial stiffness and spatial damping that are task-space impedance parameters of an end effector of the robotic system, and wherein the spatial force may be a six-dimensional force or torque vector measured at the end effector. Furthermore, the method may further comprise of deriving the spatial stiffness and spatial damping from joint-space stiffness and damping values of the robotic system using a Jacobian matrix transformation.

According to other aspects of the present disclosure, the method may include encoding and fusing the data from the multi-modal sensor which may include processing the visual data through a visual feature extractor network and modulating the visual features with the physical interaction data via feature-wise linear modulation (FiLM) or an equivalent fusion mechanism, such that the physical interaction data influences intermediate activations of the visual feature extractor network to produce the unified latent representation.

According to other aspects of the present disclosure, the method may include a fused learning representation z_t being produced by a multi-modal fusion approach that is algorithm-agnostic and implementation-independent, the operation may be any technique that functionally combines visual inputs and physical interaction inputs into a joint latent.

According to other aspects of the present disclosure, the joint latent may include without limitation, early-, intermeiate-, or late-fusion schemes; deterministic or probabilistic fusion; attention-, concatenation-, pooling-, gating-, modulation-, encoder-decoder-, graph-, kernel-, transformer-, or recurrent-based fusion; and any hybrid or sequential combination thereof, and wherein substitutions, reorderings, or parameterizations of the fusion algorithm that preserve said functional combination fall within the scope.

According to other aspects of the present disclosure, the physical interaction inputs may include spatial force, spatial stiffness, spatial damping, and gripper force.

According to other aspects of the present disclosure, the predictor network may be a Predictive Latent Dynamics Model (PLDM) comprising an encoder-predictor architecture, wherein an encoder neural network, referred to as a Sensorimotor Fusion Encoder, generates a current latent representation from multi-modal sensor data, and a predictor neural network receives the current latent representation and outputs a future latent representation. Furthermore, the predictor neural network may be trained to minimize a difference between its output and a target latent representation produced by the encoder from actual future sensor data.

According to other aspects of the present disclosure, the predictor network may be an action-conditioned model that receives, in addition to the current latent representation, an action command applied by the robotic system at the current time, and outputs the future latent representation conditioned on the action command, enabling the model to capture how the robotic system's actions influence future states.

According to other aspects of the present disclosure, the predictor network may include a recurrent state-space model that maintains a hidden state across time steps, the hidden state being updated based on the current latent representation, such that the predictor network can model temporal dependencies over a sequence of states for long-horizon predictions.

According to other aspects of the present disclosure, the method may include a temporal smoothness regularization term defined as L_rate=λΣ_t [symbol] |∇_t z_t)| ▪(2@q) for successive latent representations z_t and z_(t+1), λ being a tunable weighting factor, and wherein the training cost function may comprise a prediction loss term measuring error between predicted and actual latent representations and the temporal smoothness regularization term.

According to other aspects of the present disclosure, the method may include a predictive model that is utilized as a world model in a control or planning loop for the robotic system, the world model being configured to generate simulated future states or outcomes from the latent representation, and to select or refine actions of the robotic system based on the predicted outcomes to achieve a desired task objective.

According to other aspects of the present disclosure, the method may provide that the visual feature extractor network is a convolutional neural network or a Vision Transformer (ViT) 606 that produces an embedding of the image.

According to other aspects of the present disclosure, the method may include the predictive model enabling a robot to anticipate contact forces and object motions during the task, thereby improving success rates of the task through informed action selection or adjustments.

According to other aspects of the present disclosure, the method may include any form of a learning algorithm that comprises a deep neural network that processes the visual data from a device in combination with the impedance parameters to output control actions.

According to an aspect of the present disclosure, a robotic system is provided. The system may include a multi-linkage body with multiple degrees of freedom. The system may include one or more sensors configured to measure forces at an end effector of the multi-linkage body and to capture visual data of the multi-linkage body's environment. The system may include a computing device operatively connected to the sensors and actuators, wherein the computing device may further implement a training module that adjusts parameters of the encoder and predictor networks using self-supervised learning, with a loss function that comprises a term encouraging temporal smoothness in the latent state representations over consecutive time steps. Lastly, the system may include learning a predictive model of its own dynamics and uses the model to plan or control manipulation actions with improved understanding of physical interactions.

According to other aspects of the present disclosure, the system may comprise of one or more sensors that include a device providing video or images of the environment, a six-axis force-torque sensor at the end-effector measuring spatial forces, encoders or sensing elements for determining joint stiffness, and damping and gripper force, such that all these sensor outputs are provided as inputs to the encoder network.

According to other aspects of the present disclosure, the system may comprise a computing device that is further configured to integrate the learned world model into a reinforcement learning algorithm or motion planning algorithm, such that the robotic system can predict the outcome of candidate action sequences in latent space and select an optimal action to achieve a goal state while avoiding harmful interactions, thereby leveraging the physics-aware world model for decision making.

According to other aspects of the present disclosure, the system may provide that the computing device is configured to execute an encoder network and a predictor network.

According to other aspects of the present disclosure, the system may provide that the encoder network fuses sensor inputs including the images and the force/torque measurements into a latent state representation.

According to other aspects of the present disclosure, the system may provide that the predictor network predicts one or more future latent representations from a current latent state representation.

According to other aspects of the present disclosure, the system may provide that the loss function that comprises a term encouraging temporal smoothness is the temporal smoothness regularization term.

According to other aspects of the present disclosure, the system may provide that the multi-linkage body may comprise of manipulators, bimanual arm, humanoid robots, legged robots, or any multi-linkage body that uses force torque control logic.

According to other aspects of the present disclosure, the system may comprise one or more computing devices are configured to share the training module or force feedback between the manipulators or humanoids to coordinate a collaborative manipulation task.

According to an aspect of the present disclosure, a method of training a latent dynamics model with smoothness constraints is provided. The method may include providing a sequence of state representations obtained from multi-modal observations of a system, wherein each state representation z_t may be an encoding of sensor data at time t. The method may include learning a PLDM predictive function such that PLDM(z_t) ≈z_(t+1) for the sequence, which may minimize a loss that includes a prediction error term measuring discrepancy between PLDM(z_t) and z_(t+1), a regularization term penalizing PLDM(z_t)-z_t, wherein biasing the learned predictive function toward generating representations PLDM(z_t) that change gradually relative to z_t. Furthermore, the method may provide that the system's sensor data and state representations be multi-modal or unimodal, and the smoothness constraint may enhance the realism and stability of the learned dynamics in the latent space.

According to other aspects of the present disclosure, the sequence of state representations may be derived from a robotic system's sensorimotor data including visual and force measurements, and wherein the learned predictive function may serve as a component of the world model used by the robotic system to simulate physical interaction outcomes.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a network system with client devices and servers, according to aspects of the present disclosure.

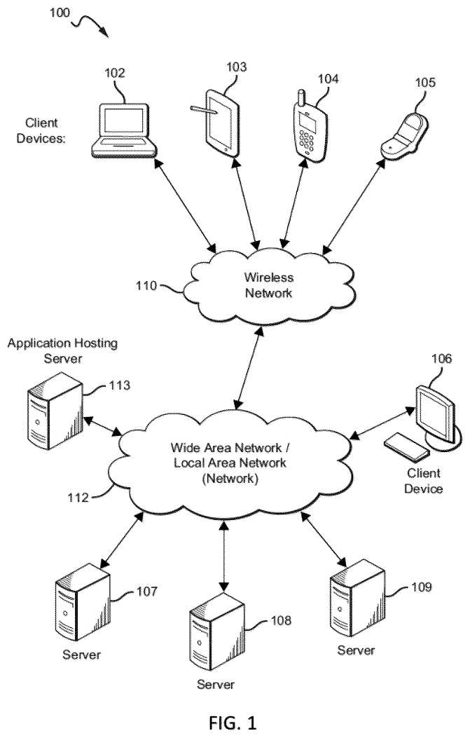

FIG. 2 illustrates a block diagram of an electronic device for robotic manipulation learning, according to aspects of the present disclosure.

FIG. 3 illustrates a flowchart of a method for generating spatial force fields in robotic manipulation, according to aspects of the present disclosure.

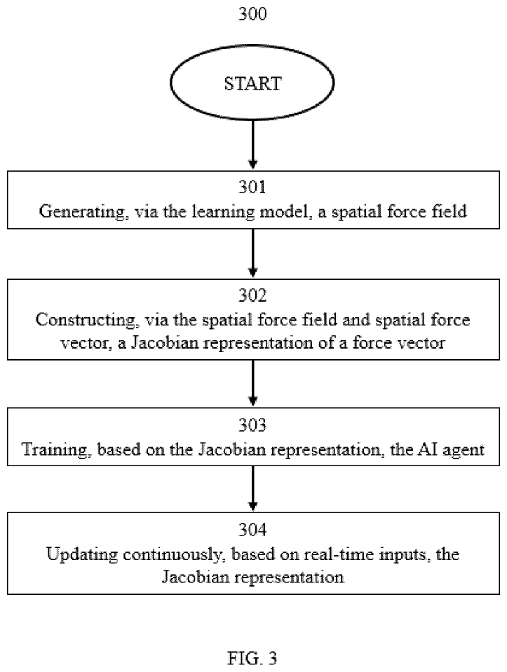

FIG. 4 illustrates a series elastic actuator mechanism with an elastic member, according to aspects of the present disclosure.

FIG. 5 illustrates a block diagram of a robotic system architecture showing data flow from robotic hardware through sensor systems to learning representation, according to aspects of the present disclosure.

FIG. 6 illustrates a block diagram of an example system architecture.

FIG. 7 illustrates a flowchart of an example training procedure for the predictive model.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The following detailed description may provide further information and embodiments of the present disclosure. For clarity, certain well-known components or techniques (such as basic robot kinematics, control algorithms, or machine learning architectures) may not be described in exhaustive detail so as not to obscure the focus of the present disclosure. Features described as optional may be introduced with “in some embodiments” or “optionally,” and functional terms (e.g., “interpret interaction”) may be implemented concretely as learning a control policy and/or predicting interaction outcomes from the disclosed representation. Terms may be used consistently (e.g., “spatial”≡Cartesian task-space). However, it will be understood by those skilled in the art that the following description, and the accompanying figures, are intended to illustrate the principles of the present disclosure and not to limit its scope. Various modifications and substitutions may be made without departing from the spirit of the present disclosure as defined by the claims.

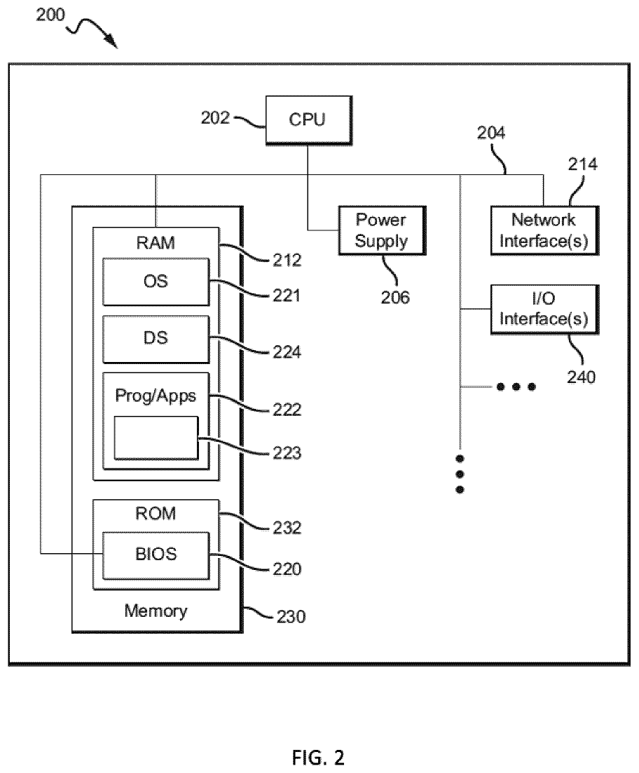

FIG. 2 illustrates a block diagram of an electronic device 200 that can implement one or more aspects of at least one of an apparatus, system and/or method for reinforcement and deep learning for a robot to interpret a physical relationship and interaction between the robot and objects (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic (e.g., an Application Specific Integrated Circuit (ASIC), a programmable/programmed logic device, memory device containing instructions, etc.), or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, the bus 204 and some of the I/O interfaces 240 can facilitate communication between components of the electronic device 200, and, in an example, can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope, and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router may act as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (“API”). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

### Impedance Control Framework and Jacobian-Based Transformations:

As used herein, “spatial force” may denote a six-dimensional end-effector wrench (moment, force) in Cartesian space; “spatial stiffness” may denote the effective 6×6 Cartesian stiffness matrix relating small pose errors to restoring forces/torques at the end effector; and “spatial damping” may denote the effective 6×6 Cartesian damping matrix relating end-effector velocity to dissipative forces/torques. Unless stated otherwise, these “spatial” quantities may be Cartesian (task-space) quantities obtained directly from sensors or derived from joint-space variables via Jacobian mappings.

At the core of the present disclosure may be an enhanced impedance control framework for a robotic manipulator. Consider a robot arm with multiple joints where q denotes the vector of joint positions and x denotes the pose of the robot's end effector in Cartesian space. The relationship between joint velocities q and end-effector velocity x may be given by the Jacobian matrix J(q):

$$\dot{x} = J ( q ) \dot{q} \qquad ( 1 )$$

where J(q) may be a matrix that, in each row, contains the partial derivatives of one component of the end-effector velocity with respect to each joint velocity. The Jacobian J thus may encode the kinematic linkage of the robot—how each joint's motion contributes to motion of the end effector.

The Jacobian may be used for mapping velocities and forces between joint space and task space. The dual relationship may be that forces can be mapped via the transpose:

$${τ}_{q} = {J}^{T} ( q ) {F}_{s p} \qquad ( 2 )$$

where Fₛₚ may be a force/moment vector applied at the end effector (spatial force in task space) and τ_{q} may be the corresponding vector of joint torques that would produce that end-effector force. This relationship (sometimes referred to as the principle of virtual work) may underlie the concept of Cartesian impedance: a stiffness or damping specified in Cartesian space can be related to an equivalent behavior in joint space, and vice versa.

In traditional impedance control, one may specify joint stiffness gains K_{Q} and damping gains D_{Q}, which may be diagonal or full matrices. Similarly, one can define Cartesian impedance (stiffness Kₓ and damping Dₓ). The present disclosure may leverage a Jacobian representation to bridge these domains. The relationship between joint-space stiffness and Cartesian stiffness may be given by:

$${K}_{x} = {J}_{K} {K}_{Q} \qquad ( 3 )$$

where J_{K} may be considered a Jacobian matrix of stiffness that maps joint stiffness to spatial stiffness. This relationship may be derived from the force/velocity Jacobian by considering differential changes in forces with respect to small displacements. This may also be called Jacobian mediated mapping. For a configuration q with body Jacobian J(q), joint-space stiffness K_{Q} and damping D_{Q}, the Cartesian stiffness may be given by:

$${K}_{x} = {J ( q )}^{- T} {K}_{Q} {J ( q )}^{- 1} \qquad ( 4 )$$

Here, K_{Q} may be the joint stiffness matrix, and J or J(q) is the body Jacobian of a manipulator or moving body. J⁻¹ may be the inverse or pseudoinverse of the Jacobian. Similarly, for cartesian damping:

$${D}_{x} = {J ( q )}^{- T} {D}_{Q} {J ( q )}^{- 1} \qquad ( 5 )$$

may define the spatial damping matrix Dₓ in terms of the joint damping D_{Q}. Note that in non-square or rank-deficient cases, the mappings may use the Moore-Penrose pseudoinverse and are evaluated in a least-squares sense, ensuring well-posed behavior near kinematic singularities. These formulas may ensure that the Cartesian impedance (stiffness/damping) realized by the robot corresponds to the set stiffness and damping in joint controllers.

Configuration dependence: Because J(q) may vary with posture, the same joint gains may induce different spatial compliance at different configurations. Near singularities, numerical stabilization may be applied to preserve bounded compliance.

In practical implementation, an equivalent approach may use the Jacobian transpose mapping for small perturbations. This may yield Kₓ=J(q)^{-T}K_{Q}J(q)⁻¹, which may be essentially the same as the formula above.

This Jacobian-based impedance mapping may be a foundation for the learning representation. It may allow computing Kₓ and Dₓ given K_{Q}, D_{Q} and enable the reverse: understanding how changes in Cartesian stiffness should be produced by altering joint stiffness.

Extended Control Law with Guidance and Compensation:

A standard robotic manipulator may be governed by the equation of motion:

$$H ( q ) q + C ( q , q ) q + G ( q ) = {τ}_{q} + {τ}_{ext} \qquad ( 6 )$$

where H(q) may be the inertia matrix, C(q, q) may represent Coriolis and centrifugal forces, G (q) may represent gravitational forces (expressed as joint torques), τ_{q} may be the control torques applied by the motors, and τₑₓₜ may be external torques (resulting from interaction forces with the environment, mapped to the joints). In an impedance-controlled system, the control torques τ_{q} may often be set to mimic a spring-damper system behavior. For example, a joint-space impedance controller might use:

$${τ}_{q} = {K}_{Q} ( {q}_{target} - q ) + {D}_{Q} ( {\dot{q}}_{target} - \dot{q} ) \qquad ( 7 )$$

where q_{target}, q_{target} may be reference trajectories for joint angles and velocities (which could be constant if we just want the robot to hold a position). When such a law may be substituted into the full dynamics, the closed-loop system may behave like a mass-spring-damper. Similarly, a task-space impedance control law can be written as:

$${F}_{ctrl} = {K}_{x} ( {X}_{target} - {X}_{e e} ) + {D}_{x} ( {X}_{target} - {X}_{e e} ) \qquad ( 8 )$$

where Xₑₑ and Xₑₑ may be the actual end-effector pose and velocity, and X_{target}, X_{target} may be the desired pose and velocity. This F_{ctrl} may then be mapped to joint torques via τ_{q}=J^{T}F_{ctrl}. This may be the basic impedance control behavior in task space.

The present disclosure may augment this control scheme by adding an external or learned guidance force term and compensating for model-known forces. The guidance force Fₛₚ may originate from an AI decision or a higher-level planner. For instance, in a learning scenario, the AI agent might output a force vector representing “push in this direction with a certain magnitude” as part of its policy. That Fₛₚ may act like a feed-forward command that drives the robot intentionally. The impedance terms Fᵢₘₚ_{ₓ}=KₓΔX+DₓΔX may ensure that even while following that command, the robot's behavior has a compliant nature—if the robot overshoots or encounters an unexpected obstacle, the spring-like and damper-like responses will modulate the force. Finally, adding F_{gravity}+F_{coriolis} (which may correspond to G(q) and part of C(q, q) mapped to Cartesian space) may mean the controller proactively cancels out predictable gravitational loads and dynamic biases. This may allow the commanded force F_{ctrl} to be effective in achieving the desired interaction, rather than being spent on just counteracting the robot's own weight or momentum. The net effect may be a hybrid force-position control strategy that can be tuned or learned: Fₛₚₐₜᵢₐₗ can be seen as a force command (or a desired force to apply), while Kₓ, Dₓ may define how deviations in position/velocity translate to additional corrective forces (which may be effectively position control behavior). The combination may yield a robust controller for tasks like contact-rich manipulation, assembly, or human-robot interaction, where you want the robot to exert specific forces but also not to be completely rigid.

Each control cycle may: (1) acquire synchronized vision and force/impedance signals; (2) form the representation (spatial-form or joint-form); (3) compute the agent output (guidance force and/or updated impedance targets); (4) synthesize the commanded wrench using guidance Fₛₚ, reactive impedance terms Kₓ\tilde{x}+Dₓ\tilde{x}, plus gravity/Coriolis compensation; and (5) apply actuator torques. This online loop may run at standard impedance-control rates, ensuring responsive, compliant interaction during learning or deployment.

From a learning perspective, the extended control law may provide an excellent platform for an AI agent to operate: the agent could adjust Fₛₚₐₜᵢₐₗ, or even modulate Kₓ, Dₓ in real time, and immediately see the outcome in terms of the effect on the environment (through sensor readings). Because Kₓ and Dₓ can themselves be functions of the Jacobian and joint gains, an advanced agent might choose joint impedance settings as part of its action to indirectly shape the Cartesian behavior. The representation we provide to the agent may capture all the necessary pieces (current forces, stiffnesses, etc.) so that the agent can make an informed decision.

### Learning Representation and AI Integration:

A key novel aspect of the present disclosure may be the formulation of a learning representation that encapsulates the physical interaction dynamics (impedance parameters and forces) of the robotic system. Rather than learning directly from raw sensor streams or low-level states, the AI agent may be provided with a higher-level state representation that reflects the current force interaction and impedance configuration. This representation may be used in various learning frameworks. Two representative forms of this learning representation may be described:

Spatial Impedance Representation (First Form): In this form, the state may include: Spatial Force Fₛₚ: A 6-dimensional vector representing force and moment at the end effector, obtained from sensors or estimated via joint torques. Spatial Stiffness Kₓ: The current Cartesian stiffness matrix. Spatial Damping Dₓ: The current Cartesian damping matrix. End Effector Pose Xₑₑ: Position and orientation of End Effector in the workspace. Gripper Force F_{gripper}: Force applied by the gripper. Vision Data: RGB images, depth maps, or processed visual features from cameras observing the workspace.

These components together may form a comprehensive snapshot of the robot's interaction state. For example, in a task like inserting a peg into a hole, Fₛₚ would tell the agent if it's pressing the peg against a side (force spikes), Kₓ, Dₓ would tell if the robot is in a compliant mode or a stiff mode, Xₑₑ gives the position and orientation of the peg relative to the hole, F_{gripper} indicates if the peg is being held securely, and the camera image can help locate the hole and guide alignment. An AI policy network could take all this information and decide how to adjust the robot's motion or impedance next (e.g., move slightly in a direction or increase stiffness to correct an error).

Joint Impedance Representation (Second Form): This form may include: Joint Torque T_{Q}: The end-effector 6D force/moment. Jacobian J: The current Jacobian matrix encoding kinematic state. Joint Stiffness K_{Q}: Joint-space stiffness matrix or vector. Joint Damping D_{Q}: Joint-space damping matrix or vector. Joint Angles, Gripper Force, and Vision Data: Same as above.

This second form may provide more raw information rather than pre-computed Cartesian stiffness/damping. An AI agent using this form could internally compute Kₓ, Dₓ via the Jacobian if needed, or learn to implicitly understand their effect.

It should be noted that the present disclosure may not be limited to exactly these two forms or these specific variables. These may be provided as illustrative examples of how the necessary information can be packaged. Any representation that includes at least the key elements—some form of force measurement, and some form of impedance parameters (whether in joint or task space, or both)—may fall within the scope, as such representations enable learning of the physical interaction. Additional information may be included as needed (for example, the robot's joint angles could also be included, or the history of forces, etc.), and some information could be omitted in certain embodiments (for instance, vision data might not be used in a purely contact-driven task). The underlying principle may be that the representation must capture the dynamic interaction state in a meaningful way for the AI to learn from it.

Multimodal fusion embodiment: In one embodiment, a vision module (CNN/ViT) may encode images to feature tokens, and a physics module (MLP) may encode one of the learning representations, eg. {Fₛₚ, Kₓ or K_{Q}, Dₓ or D_{Q}, Xₑₑ, F_{gripper}} to a physical feature vector. A fusion layer may concatenate or apply cross-attention/FiLM (Feature wise linear modulation) to combine these modalities, yielding a fused latent \hat{z}ₜ used by the policy or predictive model. This modular design may preserve units/semantics of physical channels while allowing the visual pathway to contribute contextual priors.

Integration with Learning Methods: The representation may be used as input to AI learning processes. In reinforcement learning: the state may be the learning representation, actions could be adjustments to force control parameters, impedance parameters and/or joint positions, and rewards may encourage desired manipulation outcomes. The representation may enable efficient learning by allowing agents to identify patterns such as “when stiffness is high, small position errors lead to big force changes.”

Temporal modeling. In some embodiments, the agent may consume a time window zₜ₋ₖ, . . . , zₜ to capture dynamic trends (e.g., slip onset, force ramps). This may be realized by a recurrent unit (GRU/LSTM) or by stacking recent latents. Long-horizon predictors (e.g., attention-GRU/transformers) may maintain compressed memory over tens to hundreds of steps, improving stability in contact-rich tasks and enabling anticipation of configuration-dependent compliance changes.

Crucially, because the agent's state may be rich in physical information, the agent can learn much more efficiently. It may identify patterns such as “when the stiffness is high, small position errors lead to big force changes” or “if the force is increasing rapidly, maybe I should reduce stiffness to avoid overshoot.” These may be exactly the kind of nuanced strategies human operators use (e.g., when feeling resistance, become more compliant). The representation may essentially allow the AI to feel in simulation or in the learning process what a human would feel when manipulating objects, rather than treating the environment as a black box.

Other learning paradigms may be applied: imitation learning may record demonstration sequences, supervised learning may create labeled datasets, and unsupervised learning may predict future forces or states from current ones.

The representation may be equally applicable whether the learning happens online on the robot (trial-and-error in real time) or offline (from data or simulation). For instance, an AI agent could be first trained in simulation with a physics engine, where it has access to simulated force readings and can modulate stiffness, then transferred to a real robot.

Initial training data may be obtained via human demonstrations or teleoperated runs, where all relevant sensor data is recorded and converted into the Jacobian-based impedance representation. These demonstration data points may be labeled as successful instances for pre-training or reward shaping.

Training and transfer: The representation's physically grounded channels may facilitate simulation-to-real transfer by aligning force/impedance units across domains. In some embodiments the agent may be pre-trained in simulation (including impedance modulation) and fine-tuned on hardware. In addition, demonstration data (tele-operation or back-drive) may be converted into the same representation to initialize policies by imitation or to shape rewards, enabling rapid convergence on contact-rich tasks.

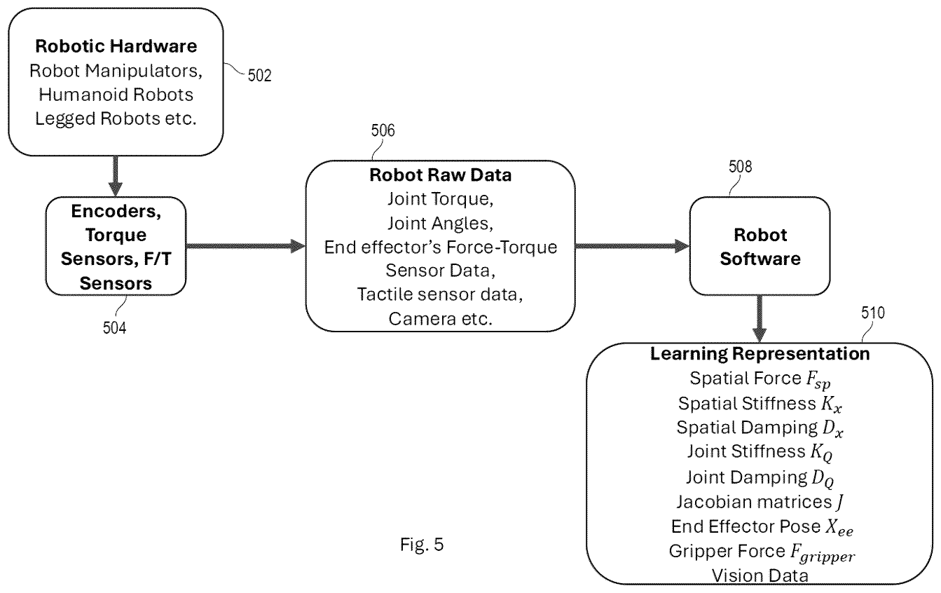

FIG. 5 illustrates a block diagram of a robotic system architecture showing data flow from robotic hardware through sensor systems to learning representation, according to aspects of the present disclosure. The robotic hardware 502 may include various types of robotic platforms such as robot manipulators, humanoid robots, and legged robots that serve as the physical foundation of the system. The sensor system 504 may comprise multiple sensing modalities including encoders for measuring joint positions and velocities, torque sensors for detecting joint-level forces, and force/torque (F/T) sensors for measuring end-effector interactions with the environment.

The sensor system 504 may generate robot raw data 506 that encompasses comprehensive information about the robot's state and interactions. This raw data may include joint torque measurements from individual actuators, joint angle positions from encoders, end effector force-torque sensor data providing six-dimensional force and moment information, tactile sensor data from contact surfaces, and camera data from vision systems observing the robot's workspace. The robot raw data 506 may be processed by robot software 508 that transforms the raw sensor measurements into structured information suitable for learning algorithms.

The robot software 508 may output a learning representation 510 that encapsulates the key physical interaction parameters needed for artificial intelligence learning. This learning representation 510 may include spatial force vectors representing end-effector forces and moments, spatial stiffness matrices defining Cartesian compliance characteristics, spatial damping matrices capturing velocity-dependent force responses, joint stiffness parameters for individual actuator compliance, joint damping parameters for actuator velocity responses, Jacobian matrices encoding kinematic relationships between joint and task spaces, end effector pose information providing position and orientation data, gripper force measurements from end-effector grasping systems, and vision data from cameras monitoring the manipulation environment. The systematic flow from robotic hardware 502 through sensing and processing stages to the final learning representation 510 may enable artificial intelligence agents to access structured physical interaction information rather than requiring direct interpretation of raw sensor streams.

### Multi-Agent and Distributed Learning Embodiments:

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

The present disclosure relates to systems and methods for learning physical interaction dynamics in robotic manipulation using impedance control principles. The disclosed approach leverages Jacobian matrix transformations to create learning representations that enable artificial intelligence agents to interpret and respond to physical interactions between robotic manipulators and objects or environments.

The robotic manipulation system may operate according to fundamental dynamic equations that govern the motion and control of articulated robotic manipulators. A general equation of motion for an articulated body in a rigid body system while experiencing external torque may be expressed as:

$${T}_{CTRL} = H \cdot {Q}_{D D O T} + C + G + {T}_{EXT} \qquad ( 9 )$$

where T_{CTRL} represents control torque, T_{EXT} represents external torque, H represents the inertia matrix, Q_{DDOT} represents joint acceleration, C represents the Coriolis term on the system, and G represents gravity torque.

The control law that may illustrate the impedance behavior of a system may be shown as:

$${T}_{CTRL} = {K}_{Q} ( {Q}_{R E F} - Q ) + {D}_{Q} ( {Q}_{REF\_DOT} - {Q}_{D O T} ) + H \cdot {Q}_{REF\_DDOT} + C + G \qquad ( 10 )$$

where K_{Q} represents joint stiffness, D_{Q} represents joint damping, Q_{REF} and Q_{REF_DOT} represent reference joint positions and velocities, and Q and Q_{DOT} represent actual joint positions and velocities.

If the control law is inserted into the equation of motion, an actual joint space impedance control system with a closed loop may be revealed:

$${T}_{Q} = {K}_{Q} ( {Q}_{R E F} - Q ) + {D}_{Q} ( {Q}_{REF\_DOT} - {Q}_{D O T} ) + H ( {Q}_{REF\_DDOT} - {Q}_{D D O T} ) \qquad ( 11 )$$

Interpreting the control law in task space, the task space control system may be shown as:

$${F}_{i m {p}_{x}} = {K}_{x} ( {X}_{R E F} - X ) + {D}_{x} ( {X}_{REF\_DOT} - {X}_{D O T} ) + M ( {X}_{REF\_DDOT} - {Q}_{D D O T} ) \qquad ( 12 )$$

where Fᵢₘₚ_{ₓ} represents the task space impedance force, Kₓ represents spatial stiffness, and Dₓ represents spatial damping.

A typical Jacobian matrix may illustrate a functional relationship between an end effector's velocity in 6-dimensional space and joint velocities:

$${X}_{D O T} = J \cdot {Q}_{D O T} \qquad ( 13 )$$

where J represents the Jacobian matrix that comprises partial differential terms of Cartesian space and joint space.

A similar concept may be applied to establish a relationship between a feedforward or guidance spatial force and joint torque, as well as end effector acceleration and joint torque:

$${F}_{S P} = {J}_{F} \cdot {T}_{Q} \qquad ( 14 )$$

$${F}_{S P} = {J}^{- T} \cdot {T}_{Q} \qquad ( 15 )$$

where F_{SP} represents a spatial force in 6-dimensional space, J_{F} represents Jacobian of force, and T_{Q} represents joint torque. Note that J_{F} is equivalent to J^{-T}, where J can be body Jacobian or space Jacobian that depends on the reference frame where the body is defined.

$$A = J \cdot {Q}_{D D O T} + {J}_{D O T} \cdot {Q}_{D O T} \qquad ( 16 )$$

where A represents spatial acceleration, J represents Jacobian, Q_{DDOT} represents joint acceleration, J_{DOT} represents the derivative of Jacobian matrix with respect to joint space, and Q_{DOT} represents joint velocities.

A non-typical Jacobian representation may be derived to establish a functional relationship between spatial stiffness and joint stiffness to illustrate the change of spatial stiffness over joint stiffness:

$${K}_{x} = {J}_{K} \cdot {K}_{Q} \qquad ( 17 )$$

$${K}_{s p} = {K}_{x} \qquad ( 18 )$$

where K_{SP} represents spatial stiffness, J represents Jacobian matrix of stiffness, and K_{Q} represents joint stiffness.

$${D}_{x} = {J}_{D} \cdot {D}_{Q} \qquad ( 19 )$$

$${D}_{sp} = {D}_{x} \qquad ( 20 )$$

where D_{SP} represents spatial damping, J_{D} represents Jacobian matrix of damping, and D_{Q} represents joint damping.

An inverse relationship may be shown as follows, where these relationships can be interpreted through Jacobian mediated mapping as well, where J is the Jacobian matrix:

$${K}_{Q} = {J}_{K}^{TRANSPOSE} \cdot {K}_{x} \qquad ( 21 )$$

$${D}_{Q} = {J}_{D}^{TRANSPOSE} \cdot {D}_{x} \qquad ( 22 )$$

Another form of inverse relationship may also be shown as follows, where such relationships can be interpreted through the Jacobian mediated mapping, where J is the Jacobian matrix:

$${K}_{Q} = {J}^{T} \cdot {K}_{x} \cdot J \qquad ( 23 )$$

$${D}_{Q} = {J}^{T} \cdot {D}_{x} \cdot J \qquad ( 24 )$$

In an embodiment, upon establishing joint-space impedance control where joint acceleration is zero, the control scheme may be:

$${T}_{Q\_RE F} = {K}_{{Q}_{i}} ( {Q}_{R E F} - Q ) + {D}_{{Q}_{i}} ( {Q}_{REF\_DOT} - {Q}_{D O T} ) \qquad ( 25 )$$

K_{Q}_{ᵢ} and D_{Q}_{ᵢ} may be interpreted from joint space to task space, such that the target joint torque may be:

$${T}_{Q\_RE F} = {J}_{K}^{T} \cdot {K}_{x} ( {Q}_{R E F} - Q ) + {J}_{D}^{T} \cdot {D}_{x} ( {Q}_{REF\_DOT} - {Q}_{D O T} ) \qquad ( 26 )$$

$${T}_{Q\_RE F} = {J}^{T} \cdot {K}_{x} \cdot J ( {Q}_{R E F} - Q ) + {J}^{T} \cdot {D}_{x} \cdot J ( {Q}_{REF\_DOT} - {Q}_{D O T} ) \qquad ( 27 )$$

As a nonlimiting example, to further simplify:

$${T}_{Q\_RE F} = {J}_{K}^{T R A N S P O S E} \cdot {K}_{x} \cdot Δ Q + {J}_{D}^{T R A N S P O S E} \cdot {D}_{x} \cdot {Q}_{D O T} \qquad ( 28 )$$

$${T}_{Q\_RE F} = {J}^{T} \cdot {K}_{x} \cdot J \cdot Δ Q + {J}^{T} \cdot {D}_{x} \cdot J \cdot {Q}_{D O T} \qquad ( 29 )$$

In an embodiment where a task space impedance force Fᵢₘₚ_{ₓ} may be applied to the system, T_{Q_REF} of every joint may be recorded and encoded into:

$${F}_{{imp}_{x}} = {K}_{x} ( {X}_{REF} - X ) + {D}_{x} ( {X}_{REF \_ DOT} - {X}_{DOT} ) \qquad ( 30 )$$

$${F}_{{imp}_{x}} = {J}_{K} \cdot {K}_{Q} ( {X}_{REF} - X ) + {J}_{D} \cdot {D}_{Q} ( {X}_{REF \_ DOT} - {X}_{DOT} ) \qquad ( 31 )$$

$${T}_{Q \_ REF} = {K}_{Q} ( {Q}_{R E F} - Q ) + {D}_{Q} ( {Q}_{REF \_ DOT} - {Q}_{D O T} ) \qquad ( 32 )$$

$${T}_{Q \_ REF} = {J}_{K}^{TRANSPOSE} \cdot {K}_{x} \cdot Δ Q + {J}_{D}^{TRANSPOSE} \cdot {D}_{x} \cdot {Q}_{D O T} \qquad ( 33 )$$

Where task space impedance force may be interpreted in the context of impedance control in the form:

$${F}_{i m {p}_{x}} = {K}_{x} ( {X}_{REF} - X ) + {D}_{x} ( {X}_{REF \_ DOT} - {X}_{DOT} ) \qquad ( 34 )$$

While, in one such example, spatial stiffness may be interpreted as:

$${K}_{x} = ( {F}_{{imp}_{x}} - ( {D}_{x} ( {X}_{REF \_ DOT} - {X}_{D O T} ) ) ) / ( {X}_{R E F} - X ) \qquad ( 35 )$$

Accordingly, spatial damping may be interpreted as:

$${D}_{x} = ( {F}_{{imp}_{x}} - ( {K}_{x} ( {X}_{REF} - X ) ) ) / ( {X}_{REF \_ DOT} - {X}_{DOT} ) \qquad ( 36 )$$

Encoding into this representation may require a numerical approximation method to derive the Jacobian matrix of stiffness J_{K} and Jacobian matrix of damping J_{D}.

A direct and dynamic relationship may be established between stiffness, damping, and task space impedance force, derived from the relationship between spatial force and joint torque:

$${F}_{SP} = {J}^{- T} \cdot {T}_{Q} \qquad ( 37 )$$

Such that

$${F}_{i m {p}_{x}} = {J}^{- T} \cdot {T}_{Q} , note that {J}_{F} = {J}^{- T} \qquad ( 38 )$$

$${T}_{Q} = {K}_{Q} \cdot Δ Q + {D}_{Q} \cdot {Q}_{D O T} \qquad ( 39 )$$

$${F}_{i m {p}_{x}} = {J}^{- T} \cdot ( {K}_{Q} \cdot {Q}_{D O T} + {D}_{Q} \cdot {Q}_{DDOT} ) \qquad ( 40 )$$

$${F}_{i m {p}_{x}} = {1}^{- T} ( {J}_{K}^{T} \cdot {K}_{x} \cdot Δ Q + {J}_{D}^{T} \cdot {D}_{x} \cdot {Q}_{D O T} ) \qquad ( 41 )$$

$${F}_{i m {p}_{x}} = {J}^{- T} ( {J}^{T} \cdot {K}_{x} \cdot J \cdot Δ Q + {J}^{T} \cdot {D}_{x} \cdot J \cdot {Q}_{D O T} ) \qquad ( 42 )$$

$${J}_{F} = {J}^{- T} = {F}_{{imp}_{x}} / ( {K}_{Q} \cdot Δ Q + {D}_{Q} \cdot {Q}_{DOT} ) \qquad ( 43 )$$

As described herein, J_{F} may not only represent the change of task space impedance force in 6-dimensional space with respect to joint torques but may also demonstrate the relations of how the task space impedance force in 6-dimensional space reacts with the change of joint stiffness and joint damping as well as spatial stiffness and spatial damping.

If the above mathematical model and representation may be applied into a learning mechanism, regardless of whether it is in the context of reinforcement learning and/or deep learning, a linearity and optimality may be identified through learning from the relationship between stiffness, damping and spatial force. For example, in the context of reinforcement learning, the framework may be as follows:
a. Action space—Spatial force OR Joint torque;
b. State space that at least is one of the learning representations below:
   i. First Form, Spatial Impedance Representation that involves spatial force, spatial impedance that includes stiffness and damping, end effector pose, gripper force, vision data
   ii. Second Form, Joint Impedance Representation that involves joint torque, joint impedance that includes stiffness and damping, joint angles, gripper force, vision data
c. A deep neural network may receive state space as inputs, inferring spatial control force or joint torques to drive the robot to move the goal or complete a task.

Another framework may involves different sets of state space and action space, where both state space and action space can be the same representation:
a. State space & Action space
   i. First Form, Spatial Impedance Representation that involves spatial force, spatial impedance that includes stiffness and damping, end effector pose, gripper force, vision data
   ii. Second Form, Joint Impedance Representation that involves joint torque, joint impedance that includes stiffness and damping, joint angles, gripper force, vision data
b. A deep neural network may receive state space as inputs, inferring state space that is also an action space to drive the robot to move the goal or complete a task.

In the context of reinforcement learning, the closer the spatial force is towards the actual required force, the higher the reward, for example, as weighed in the neural network. The learning representation may not only be a breakthrough in reinforcement learning but also may have significant potential for deep learning applications by providing a more efficient state-space abstraction and improved action encoding, enhancing the capacity of deep neural networks to model complex, high-dimensional relationships in data.

Understanding relationships between forces, stiffness, and damping parameters may be fundamental to achieving compliant behavior. The disclosed system may address limitations by providing structured learning representations that incorporate spatial impedance parameters derived through Jacobian-based transformations.

The system may formulate learning representations including spatial force vectors, spatial stiffness matrices, and spatial damping matrices derived from joint-space parameters using Jacobian transformations. The spatial stiffness may be defined as Kₓ=J(q)^{-T}K_{Q}J(q)⁻¹, where J or J(q) represents the Jacobian matrix and K_{Q} represents joint-space stiffness.

The learning representation may enable AI agents to reason about physical interactions in a more informed manner, receiving structured information that explicitly captures impedance characteristics rather than learning from raw sensor data.

The impedance-aware representation may narrow the search space for control, may encode physical constraints explicitly, and may improve sample efficiency, safety, and simulation-to-real transfer compared to raw-sensor or pose-only states. By exposing posture-dependent compliance characteristics, the system may generalize across different objects, contact scenarios, and robot configurations with reduced trial-and-error learning requirements.

The system may support multiple forms of learning representations to accommodate different AI architectures. Both spatial and joint-space forms may enable AI agents to learn manipulation strategies that account for physical interaction dynamics.

The disclosed approach may integrate with various AI learning methods. Initial data sets may be derived from human demonstrations, with force sensor data converted into Jacobian matrices of stiffness and damping. The system may also support distributed learning architectures.

The system may extend traditional impedance control laws to incorporate guidance forces and dynamic compensation. The extended control law may compute commanded forces as a combination of guidance forces from AI agents, reactive impedance forces responding to position and velocity errors, and compensation terms for gravitational and Coriolis effects. This approach may enable robots to perform deliberate actions while maintaining compliant behavior during unexpected contacts or disturbances.

The system may implement novel Jacobian-based transformations that establish mathematical relationships between joint-space impedance parameters and spatial impedance parameters. These transformations may enable dynamic mapping of stiffness and damping characteristics between different coordinate systems based on the current configuration of the robotic manipulator. The transformations may provide a systematic approach for converting impedance parameters while maintaining consistent physical behavior across joint space and task space representations.

The joint-space stiffness matrix K_{Q} may be configured as a diagonal matrix where each joint has an independent stiffness setting. In this configuration, each diagonal element may represent the stiffness value for a corresponding joint, allowing individual control of joint compliance without coupling effects between joints. The diagonal structure may simplify the computation of matrix inverses required in the Jacobian-based transformations and may provide intuitive control over individual joint behavior.

Alternatively, the joint stiffness matrix K_{Q} may be implemented as a full matrix for coupled joints rather than a diagonal matrix. The full matrix representation may include off-diagonal terms that capture coupling effects between joints, enabling more sophisticated impedance behaviors that account for mechanical coupling or desired coordination between joint motions. The full matrix approach may provide greater flexibility in shaping the overall impedance characteristics of the robotic system.

The Jacobian matrices for stiffness and damping may be derived from the fundamental Jacobian matrix through differential relationships that account for how impedance parameters transform between coordinate systems. These conceptual Jacobian matrices may encode the sensitivity of spatial impedance parameters to changes in joint impedance parameters, providing a systematic framework for bidirectional parameter conversion.

The Jacobian-based impedance transformations may enable dynamic mapping of impedance parameters that adapts to changes in robot configuration. As the robotic manipulator moves through different poses, the Jacobian matrix J(q) may change according to the current joint angles, causing corresponding changes in the spatial impedance characteristics even when joint impedance parameters remain constant. This configuration-dependent behavior may allow the system to automatically adjust spatial compliance based on the geometric properties of the current robot pose.

The transformations may account for kinematic singularities and near-singular configurations where the Jacobian matrix becomes ill-conditioned or loses rank. In such situations, the system may employ regularization techniques or alternative transformation methods to maintain stable impedance behavior. The pseudoinverse of the Jacobian matrix may be used instead of the standard inverse to provide robust transformations in the presence of kinematic constraints or redundancy.

The mathematical framework may support real-time computation of impedance transformations during robot operation, enabling adaptive impedance control strategies that respond to changing task requirements or environmental conditions. The transformations may be computed at each control cycle to ensure that spatial impedance parameters accurately reflect the current kinematic configuration and joint impedance settings. The guidance force generated by the artificial intelligence learning algorithm may be based on learned manipulation strategies for specific task contexts, incorporating knowledge gained from previous interactions and training experiences to optimize force application and compliance characteristics for current manipulation scenarios.

The bidirectional nature of the transformations may enable artificial intelligence agents to reason about impedance adjustments in either joint space or task space according to the requirements of specific learning algorithms or control strategies. An AI agent may choose to modify joint stiffness parameters directly or may specify desired spatial stiffness characteristics that are then converted to appropriate joint settings through the inverse transformations.

The task space or spatial impedance force representation may establish fundamental relationships between impedance parameters and force generation in robotic manipulation systems. The spatial or task space impedance force vector Fᵢₘₚ_{ₓ} may be expressed in terms of spatial stiffness and damping parameters through the impedance control relationship:

$${F}_{{imp}_{X}} = {K}_{x} ( {X}_{REF} - X ) + {D}_{X} ( \dot{{X}_{ref}} - \dot{X} ) \qquad ( 44 )$$

where Kₓ represents the spatial stiffness matrix, Dₓ represents the spatial damping matrix, X_{ref} and X_{ref} represent reference position and velocity in task space, and X and \dot{X} represent actual end effector position and velocity.

The spatial impedance force relationship may be reformulated using the Jacobian-based impedance transformations to express spatial force in terms of joint-space parameters. This alternative formulation may be expressed as:

$${F}_{i m {p}_{x}} = {J}^{- T} \cdot ( {K}_{Q} \cdot {Q}_{D O T} + {D}_{Q} \cdot {Q}_{D D O T} ) \qquad ( 45 )$$

$${F}_{i m {p}_{x}} = {1}^{- T} ( {J}_{K}^{T} \cdot {K}_{x} \cdot Δ Q + {J}_{D}^{T} \cdot {D}_{x} \cdot {Q}_{D O T} ) \qquad ( 46 )$$

where J_{K} represents the Jacobian matrix of stiffness, J_{D} represents the Jacobian matrix of damping, K_{Q} represents joint-space stiffness parameters, and D_{Q} represents joint-space damping parameters. This formulation may enable the system to compute spatial forces directly from joint-level impedance settings while accounting for the kinematic configuration of the manipulator.

The spatial stiffness matrix Kₓ may be derived from measured or computed spatial forces through the relationship:

$${K}_{x} = ( {F}_{{imp}_{x}} - ( {D}_{x} ( {X}_{REF \_ DOT} - {X}_{D O T} ) ) ) / ( {X}_{REF} - X ) \qquad ( 46 )$$

This derivation may enable the system to estimate spatial stiffness characteristics based on observed force responses to position deviations, accounting for the damping component of the total force. The spatial stiffness computation may provide feedback for learning algorithms that need to understand the current compliance characteristics of the robotic system.

Similarly, the spatial damping matrix Dsp may be derived through the relationship:

$${D}_{x} = ( {F}_{{imp}_{x}} - ( {K}_{x} ( {X}_{REF} - X ) ) ) / ( {X}_{REF \_ DOT} - {X}_{DOT} ) \qquad ( 47 )$$

This derivation may allow the system to estimate damping characteristics from force measurements while accounting for the stiffness contribution to the total force. The damping estimation may provide information about velocity-dependent force responses that artificial intelligence agents can use to understand and predict system behavior during dynamic interactions.

The force Jacobian J_{F} and Jacobian matrix J may establish a direct relationship between spatial impedance forces and joint torques according to:

$${F}_{i m {p}_{x}} = {J}^{- T} \cdot {T}_{Q} \qquad ( 48 )$$

where τ_{Q} represents the vector of joint torques. This relationship may enable the system to estimate spatial impedance forces from joint torque measurements rather than requiring direct force sensors at the end effector. The force Jacobian may provide a mapping that accounts for the kinematic configuration and mechanical properties of the robotic manipulator.

The spatial force may also be expressed in terms of joint impedance parameters and joint motion variables through the expanded relationship:

$${F}_{i m {p}_{x}} = {J}^{- T} \cdot ( {K}_{Q} \cdot Δ Q + {D}_{Q} \cdot \dot{Δ Q} ) \qquad ( 49 )$$

where ΔQ represents joint position difference and ΔQ represents joint velocities. This formulation may demonstrate how joint-level impedance parameters and motion characteristics combine to produce spatial impedance forces at the end effector.

This computation may enable the system to determine the force Jacobian based on measured spatial forces and known joint impedance parameters and motion states. The force Jacobian may capture the sensitivity of spatial forces to changes in joint torques, providing information about how joint-level control actions translate to end effector force responses.

These Jacobian relationships may establish a direct dynamic relationship between stiffness, damping, and spatial force that artificial intelligence agents can leverage for learning manipulation strategies. These Jacobian matrices may encode not only the geometric transformation between joint torques and spatial forces but also the dynamic coupling between impedance parameters and force generation. This comprehensive relationship may enable learning algorithms to understand how adjustments to joint stiffness and damping parameters will affect the spatial force characteristics experienced during manipulation tasks.

The spatial force representation framework may provide artificial intelligence agents with multiple pathways for reasoning about force generation and impedance control. Agents may use the direct spatial impedance relationships to understand task-space behavior, or may employ the joint-space formulations to reason about individual joint contributions to overall force patterns. The bidirectional nature of the relationships may enable agents to work with whichever representation is most suitable for their learning architecture or control strategy.

The mathematical relationships may support real-time computation of spatial forces from various sensor inputs, including joint torque sensors, position encoders, and velocity measurements. The system may estimate spatial forces without requiring dedicated force sensors at the end effector, using the Jacobian-based transformations to convert joint-level measurements into task-space force information. This capability may reduce sensor requirements while providing the force feedback necessary for impedance-based learning and control. The joint torque measurements may be obtained from series elastic actuators, strain gauge sensors, or motor current feedback, providing multiple pathways for acquiring the torque data needed for force estimation and learning representation construction. The torque measurements from the one or more sensors may enable the processor to control the one or more actuators with precise force regulation and adaptive impedance characteristics.

The system may implement an extended control law that represents the ultimate evolution from the aforementioned impedance control law, combining multiple force components to achieve both compliant interaction behavior and intentional force application during robotic manipulation tasks. This extended control law represents the final, comprehensive form that may be formulated as:

$${F}_{ctrl} = {F}_{sp} + {K}_{x} Δ X + {D}_{x} Δ X + {F}_{gravity} + {F}_{coriolis} \qquad ( 50 )$$

$${F}_{ctrl} = {F}_{sp} + {F}_{i m {p}_{x}} + {F}_{gravity} + {F}_{coriolis} \qquad ( 51 )$$

where F_{ctrl} represents the total commanded force at the robot's end effector, Fₛₚ represents a guidance force component, Fᵢₘₚ_{ₓ} represents a reactive force component, where it can be interpreted as KₓΔX that is the stiffness-based reactive force term, as well as DₓΔX that is the damping-based reactive force term, F_{gravity} represents gravitational compensation forces, and F_{coriolis} represents Coriolis force compensation.

In operation, upon generation of the learning representation, the robot's control unit receives the representation either (i) as a state input to an artificial-intelligence policy that outputs the guidance force Fₛₚ and/or updated impedance targets Kₓ, Dₓ, Xₑₑ or (ii) as an action that can be joint torque T_{Q}, joint angles Q, and/or Jacobian J specifying such targets directly. Responsive thereto, the control unit executes, on-board and in real time, the extended control law of Eqs. (50)-(51) to compute the commanded end-effector force F_{ctrl}, and converts F_{ctrl} into joint-level actuator commands with T_{Q}=J^{T} F_{ctrl} applied to the manipulator at each control cycle.

As used herein, a spatial force field is the impedance-aware force representation provided to (and used by) the learning process—not a free-form prediction. Concretely, it comprises the spatial representation that includes spatial force Fₛₚ and spatial impedance parameter Fᵢₘₚ_{ₓ} at specific configuration of end effector pose Xₑₑ and specific time t. The learning model consumes the spatial or joint space learning representation to infer either a learning representation or action representation at time t+1 that contributes to F_{ctrl} where it comprises of guidance spatial force Fₛₚ and/or updated impedance parameters Kₓ and Dₓ. A joint space force field can also be generated at specific joint configuration Q and time t, where the joint space force field comprises of joint torques T_{Q}, joint impedance parameters such as K_{Q}, D_{Q}, Jacobian matrix J, and joint angles Q. Note that the Jacobian transformation can also be used to map spatial representation to joint space and to compute sensitivities, using T_{Q}=J^{T}F_{ctrl} for actuation, using a pseudoinverse or damped least-squares form of J near singularities. In this way, the force field is entirely constructed from measured interaction forces and the current impedance state—it is the structured, physically grounded signal that the learner operates on, not an unconstrained, generated artifact.

The guidance force Fₛₚ may serve as a feed-forward command that drives the robot's motion and interaction deliberately according to high-level planning objectives or operator intentions. This guidance force component may enable the robotic system to apply specific forces or execute particular motions while maintaining the compliant characteristics provided by the impedance terms. The guidance force may represent the intentional force that the robot should apply to accomplish manipulation tasks, such as pushing against an object with a specified magnitude or direction.

A higher-level planner may generate the guidance force Fₛₚ based on task requirements, environmental conditions, or learned policies from artificial intelligence agents. The higher-level planner may analyze the current manipulation context and determine appropriate force commands that will advance the robot toward task completion. The planner may consider factors such as object properties, contact constraints, and safety requirements when computing guidance forces that are integrated into the extended control law.

The guidance force may also originate from a human operator who provides teleoperation commands that are integrated into the control law. In teleoperated scenarios, the human operator may specify desired forces or motions through haptic interfaces, joysticks, or other input devices, and these commands may be translated into guidance force terms that are combined with the autonomous impedance control behavior. The integration of human operator commands may enable shared control strategies where the operator provides high-level guidance while the impedance control system maintains safe and compliant interaction with the environment.

The reactive impedance force terms Fᵢₘₚ_{ₓ}=KₓΔX+DₓΔX may provide spring-damper responses to position and velocity errors that ensure safe and compliant behavior during unexpected contacts or disturbances. The stiffness term KₓΔX may generate restoring forces proportional to position deviations from reference trajectories, where ΔX represents the difference between desired and actual end effector poses. The damping term DₓΔX may provide velocity-dependent forces that resist motion and help stabilize the system, where ΔX represents the difference between desired and actual end effector velocities.

The impedance terms may prevent excessive penetration into contacts, reduce oscillations, and provide predictable force responses to environmental interactions. When the robot encounters unexpected obstacles or experiences external disturbances, the impedance terms may automatically generate corrective forces that maintain stable contact while allowing controlled compliance. This behavior may enable the robot to adapt to variations in object positions, surface properties, or contact geometries without requiring explicit programming for each scenario.

The compensation forces F_{gravity}+F_{corioiis} may counteract known dynamic loads that would otherwise interfere with the intended force application and impedance behavior. The gravitational compensation force F_{gravity} may counteract the effects of gravity acting on the robot's links and payload, ensuring that the commanded forces are applied to the manipulation task rather than being consumed by supporting the robot's own weight. The Coriolis compensation force F_{coriolis} may counteract velocity-dependent forces that arise from the motion of the robot's links, preventing these dynamic effects from disturbing the intended interaction behavior.

In quasi-static manipulation scenarios where robot motions are slow and acceleration effects are minimal, the compensation forces may include only gravity compensation without Coriolis compensation. The simplified compensation approach may be expressed as F_{gravity} alone, reducing computational requirements while maintaining adequate dynamic compensation for low-speed manipulation tasks. The quasi-static assumption may be appropriate for many precision manipulation tasks where deliberate, controlled motions are more important than high-speed operation.

The extended control law may combine feedback control through the impedance terms with feed-forward control through the guidance and compensation terms. The feedback components may react to deviations and disturbances, while the feed-forward components may proactively apply desired forces and counteract predictable dynamic effects. This hybrid approach may enable robust manipulation performance that maintains both accuracy and compliance across a wide range of task conditions and environmental variations.

The mathematical formulation may be integrated with artificial intelligence learning algorithms that modify the guidance force Fₛₚₐₜᵢₐₗ or adjust the impedance parameters Kₓ and Dₓ based on learned policies or adaptation strategies. Learning agents may output guidance forces that represent learned manipulation strategies, while simultaneously adjusting stiffness and damping parameters to optimize compliance characteristics for specific task contexts. The extended control law may provide a flexible framework that accommodates various learning approaches while maintaining stable and safe robot behavior.

The control law may be implemented in real-time control systems where each force component is computed at the control sampling rate and combined to produce the total commanded force. The commanded force F_{ctrl} may then be converted to joint torques through Jacobian transpose mapping and applied to the robot's actuators. The real-time implementation may ensure that all force components are properly coordinated and that the resulting robot behavior reflects the intended combination of guidance, compliance, and compensation characteristics.

The first learning representation form may provide spatial parameters including six-dimensional spatial force vectors, pre-computed spatial stiffness and damping matrices, end effector pose (position/orientation in various formats), gripper force measurements, and vision data (RGB images, depth maps, or processed features). This spatial representation may enable AI agents to reason directly in task space without requiring kinematic transformations.

The second learning representation form may provide joint-level parameters including the spatial force vector, Jacobian matrix, joint-space stiffness and joint-space damping matrices (diagonal or full), joint angles, gripper forces, and vision data. This may enable AI systems to internally derive Cartesian impedance behavior and understand configuration-dependent transformations. Additional state information may include joint angles and force history over time.

Series Elastic Actuators (SEAs) may provide direct joint torque measurement through elastic member deflection. The elastic member may include flexible spokes that deflect proportionally to transmitted torque, with sensors measuring deflection for torque calculation. SEAs may act as physical force limiters and may include co-located processors running local agents that monitor deflection and adjust motor current, contributing torque data to the distributed learning architecture. The deflection of the elastic element may allow for more accurate torque measurements as well as offer more “cushioning” when interacting with objects, with each SEA joint having a co-located small processor running a local agent that monitors spring deflection and adjusts motor current based on the measured torque feedback. The SEA may be implemented in a system utilizing the feedback from the measured torque to control the force used to control the actuation motion, offering another level of data to be used in training the AI agent. The joint torque values derived from the measured deflection may be included in the learning representation as part of the spatial force vector or as joint-level force feedback data, enabling the artificial intelligence agent to understand and respond to the physical interaction dynamics at both the joint level and task space level.

The method may generate spatial force fields via learning models, construct Jacobian representations combining force fields with spatial force vectors, train AI agents using these representations, and continuously update representations with real-time inputs. The workflow may integrate mathematical frameworks with AI learning algorithms, supporting both online and offline learning approaches for adaptive robotic manipulation.

AI learning integration may support various action parameterizations (joint positions with impedance adjustments, spatial force commands, or high-level commands), reward functions encouraging force targets or safety, and learning approaches including online trial-and-error, offline pre-collected data, human demonstrations, teleoperation, behavioral cloning, dynamics modeling, and self-supervised cross-modal prediction. The system may classify contact stability and learn from expert-labeled datasets.

Distributed learning architectures may employ multiple AI agents: local joint-level agents with co-located processors handling joint-specific impedance and force data, and central coordinators integrating information across joints for higher-level manipulation strategies. Agents may communicate periodically or peer-to-peer, sharing learning representations for coordination. In one embodiment there may be a central processor hosting the AI agent that controls several actuated joints of a single robot, with the AI agent trained on data collected by one or more of the actuated joints to enable exposure to several sources of data for faster or more accurate learning. In another embodiment, an embedded system design may be utilized where each of the actuated joints may have their own individual processor, each hosting their own AI agent, with individual processors in communication with each other and/or a central processor that may have its own AI agent. The framework may support multi-robot cooperation and dynamic reconfiguration of agent responsibilities based on task requirements. Each artificial intelligence agent may collect respective data sets from torque measurements and force feedback obtained from their associated actuators and sensors, enabling coordinated learning strategies that leverage distributed sensing and processing capabilities.

Deep learning integration may combine convolutional neural networks or vision transformers for visual processing with specialized components for impedance parameters. The architecture may use early or late fusion approaches, attention mechanisms, recurrent components for temporal sequences, end-to-end learning, physics-aware loss functions, transfer learning, multi-task learning, and uncertainty estimation capabilities.

Applications may include robotic assembly (peg-in-hole insertion, circuit board connectors), human-robot interaction (tray holding with adaptive compliance), grasping and tool use (screwdriver operations with progressive stiffening), and multi-robot collaboration (coordinated carrying of fragile objects with force balancing). The learning representation may enable AI agents to recognize force patterns, adjust impedance characteristics, and coordinate manipulation strategies across diverse task scenarios. These use cases may include both physical structures in which the AI agent may inhabit as well as specific tasks to be carried out to train the AI agent and tasks to be completed by a fully trained AI agent, with applications including scenarios where it may be necessary to limit the amount of force used on external objects while still performing tasks that require various amounts of force, such as handling fragile objects like glass figurines of various shapes and weights or objects with a low tolerance for damage such as humans or animals.

AI agents may develop sophisticated control strategies including adaptive compliance to prevent jamming, progressive stiffening for increasing resistance tasks, load distribution coordination for multi-robot scenarios, stiffness-force relationship learning, force-responsive compliance adjustments, vibration damping strategies, and impedance pattern matching from demonstrations. These learned behaviors may emerge through structured feedback from the impedance-based learning representation. Unlike traditional representations that often struggle to link perception with action, this novel approach may enable robots and AI agents to form more cohesive and responsive control policies by interpreting the force sensor feedback into the representation matrix, allowing robots to better understand and react to physical surroundings while optimizing real-world tasks like navigation, manipulation, and interaction. This learning representation may be a critical advancement in embodied AI that enables systems to adapt quickly and perform complex actions with greater precision and efficiency, allowing for more sophisticated, autonomous robots in dynamic environments.

In multi-manipulator embodiments (e.g., bimanual, dual-arm, or multi-robot systems), each manipulator constructs a local learning representation comprising, at least, a spatial impedance representation (first form), or joint impedance representation (second form). A centralized learning model with controller (centralized or distributed) receives learning representation from each robot and combine them as an input to synthesize coordinated commands, including control force F_{ctrl}, joint torques T_{Q}, that satisfy task-level interaction or motion objectives (e.g., grasp stability, load sharing, and contact safety) under kinematic/dynamic constraints. Each manipulator executes the extended control law using its coordinated guidance wrench and impedance targets, with fail-safe fallback to local policies if the coordination link degrades, thereby ensuring compliant, cooperative manipulation of a shared object.

The disclosed representation and control loop may be implementable on a distributed embedded architecture with joint-resident torque/impedance loops and a synchronized fieldbus to the fusion/policy stack, enabling deterministic, low-latency execution.

### Embedded System Design and Control Integration:

System implementation may support various processor architectures (centralized, distributed, or hybrid), sensor configurations (wrist-mounted force-torque sensors, gripper force sensors, vision systems), end effector options (grippers, dexterous hands), vision-free operation for contact-driven tasks, simulation-to-real transfer approaches, and redundant degree-of-freedom configurations. These variations may provide flexibility for adapting the impedance-based learning framework to different hardware platforms and task requirements. The algorithm may be designed to be executed within a standard computerized system comprising typical computerized components, including a central processing unit (CPU), a graphical processing unit (GPU), and memory modules, with the CPU configured to interpret and process the algorithm's computer-executable instructions to determine the desired movement and characteristics of the robotic components, and memory components adapted to store the algorithm's data and parameters, facilitating real-time adjustments during execution. This integrated approach may ensure that the robotic components operate efficiently and effectively, enhancing their performance across various applications, including instances where the system includes a plurality of nodes or robotic components in communication via a distributed system.

### Series Elastic Actuator Embodiment:

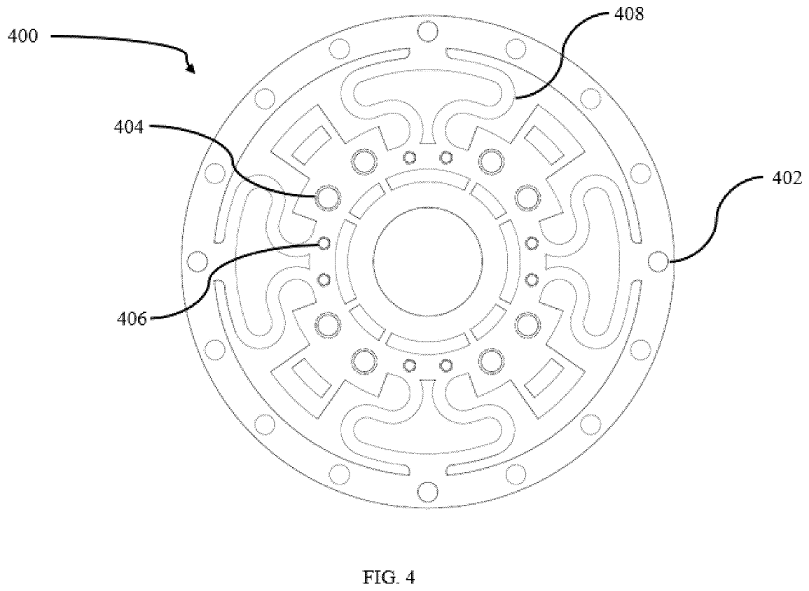

In one preferred hardware embodiment, the robotic system utilizes Series Elastic Actuators (SEAs) in the joints. An SEA includes an elastic element (such as a spring or flexible beam) between the motor and the load. The deflection of this elastic element provides a direct measurement of the torque/force at the joint (since force causes the spring to deform). FIG. 4 depicts an example SEA design: an elastic member (400) is connected to the motor output and the joint link via attachments (402, 404, 406), and has flexible spokes (408) that deflect under torque. Sensors measure this deflection. In such an arrangement, the joint torque τ_{q} is readily measured from the spring deflection, giving an immediate reading of the forces during interaction without needing a separate force-torque sensor at the wrist. This torque can be used to compute the spatial force Fₛₚ (via Fₛₚ=J^{-T}τ_{q} if needed) and to feed into the learning representation.

Using SEAs can enhance learning and control in the impedance framework: the inherent compliance of the joint allows safer interactions (the spring will absorb shocks) and provides high-fidelity torque feedback. The AI agent can be trained on data that includes these torque readings. For example, if an SEA joint's elastic element deflects by a certain amount, that corresponds to a known torque (by calibration). The agent, by observing these values, effectively is aware of the force without requiring an external sensor. Moreover, in tasks where force limiting is crucial (like handling fragile objects or interacting with humans), the SEA can act as a physical limiter (if force exceeds a threshold, the spring yields) and the agent can learn to operate near the yielding point optimally.

The SEA embodiment can be combined with the multi-agent approach: each joint's small processor (co-located with the SEA) runs an agent that monitors its spring deflection and adjusts motor current (torque) and damping at that joint. The central agent still considers the overall end-effector force and coordinates the joints. The claims of this invention encompass such variations where the source of force data might be joint-level sensors (like SEAs or strain gauges) instead of or in addition to an end-effector sensor.

### Example Use Cases

Robotic Assembly: A robot arm may learn to insert a delicate component into a tight slot (e.g., a peg-in-hole or a circuit board into a connector). Using the impedance learning representation, the robot may learn that when misalignment causes contact on one side (detected as a force spike in a certain direction), it should momentarily reduce stiffness to avoid jamming and adjust the position (perhaps guided by vision to realign) before increasing stiffness again to push in. Traditional position-control learning might simply push harder and get stuck, whereas the disclosed system may explicitly manipulate stiffness and use force sensing to guide the policy.

Human-Robot Interaction: A robot holding a tray may serve a drink to a human. The robot may need to keep the tray stable (which implies a certain stiffness against disturbances) but also react if the human unexpectedly moves the tray or adds a weight (which requires compliance to avoid spilling). An AI agent with the disclosed representation may learn to modulate the arm's stiffness in response to forces detected (someone touching or pushing the tray) and perhaps vision cues (seeing the human's hands). It may also apply a gentle force to maintain the tray level (guidance force) while letting the human make small adjustments—essentially achieving a shared control. The multi-agent aspect might involve each joint adjusting to maintain stability (e.g., wrist joint being more compliant if the human grips the tray, elbow stiffening to carry weight, etc., all coordinated by the learned policy).

Grasping and Tool Use: Consider a robot that may learn to use a screwdriver. Initially, it may need to pick up the screwdriver (using vision to locate it and a gripper force sensor to know it has a good grasp). Then to tighten a screw, it may need to push down (axial force) and twist (torsional force) with appropriate impedance—too stiff and it might strip the screw or cam out, too compliant and it won't turn. With the disclosed system, the agent may learn the right downward force and rotational stiffness by feeling the interaction (force goes up as screw tightens) and adjusting accordingly. The representation may inform it of current force and stiffness; the agent's action might increase stiffness as the screw gets tighter, but also stop when a threshold force is reached (to avoid overtightening). The gravity compensation in control may ensure that the only force it applies is what the agent intends (pushing on the screw), not fighting gravity.

Multi-Robot Collaboration: Two robotic arms may jointly carry a large, fragile panel of glass. Each arm may have a local controller with a certain stiffness. If one arm moves slightly faster, the glass might bend or stress. Through learning, the agents may coordinate stiffness: when they detect force between them (one arm feels the other pushing/pulling via the panel), they may either adjust their motion or impedance to distribute the load evenly. The representation here might include the forces each arm feels at its end effector; an agent or a coordinating system may use those to infer if the object is being strained and adjust accordingly. They may even learn to low-pass filter their force inputs (through damping adjustments) to avoid exciting any vibration modes in the glass.

### System for Predictive Learning of Physical Interaction Dynamics Using Visuo-Impedance Representations

The systems and methods for predictive learning of physical interaction dynamics using visuo-impedance representations (the “method”) may comprise the following: a multi-modal sensor data from a robotic system; encoding and a fusion of the multi-modal sensor data into a unified latent representation of the system's state; training a predictor network to predict a future latent representation of the system's state from a current latent representation; and applying a temporal smoothness regularization term in a training cost function.

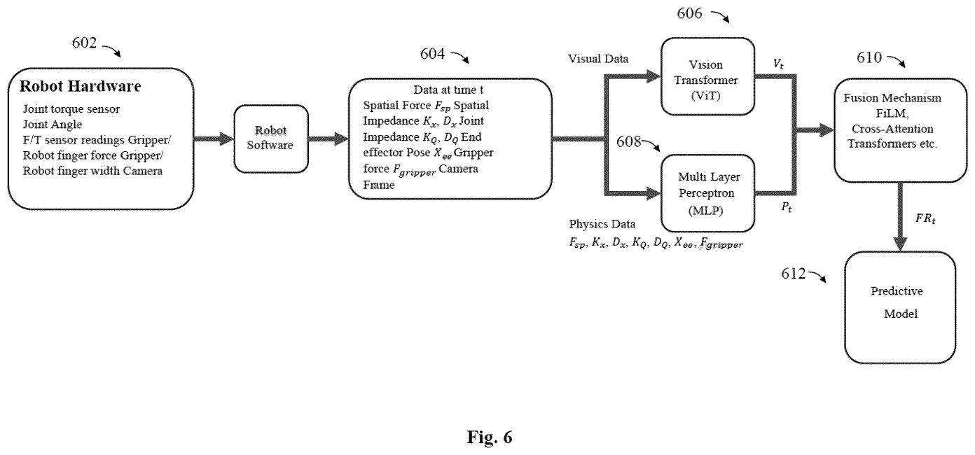

FIG. 6 illustrates an exemplary system architecture of the invention. Furthermore, FIG. 6 illustrates what is comprised in a robot hardware 602 which may include without limitation of one or more, one or more joint torque sensors, one or more F/T sensor readings, one or more gripper force, one or more gripper finger width, and a device capable of taking photos or videos.

The robot hardware 602 may be utilized to capture data at the time t 604. Data at the time t 604 may comprise of the following data: spatial force, spatial impedance, joint torques, joint impedance, joint angles, end effector pose, gripper force, and a camera frame.

Furthermore, FIG. 6 illustrates how the data at the time t 604 may be input into a Vision Transformer (ViT) 606 to produce visual data and any other data may be input into a Multi Layer Perception (MLP) 608. Furthermore, FIG. 6 further illustrates a Fusion Mechanism FiLM 610 that may fuse the visual data and other data within data at the time of t 604. This fused data may be input into a predictive model 612 that may generate future latent representations.

The present disclosure may utilize a fused representation that may combine one or more sensor modalities relevant to robotic interactions. In one embodiment, the sensor modalities may comprise of but are not limited to the following: spatial force, spatial stiffness, spatial damping, gripper force, and visual data.

Spatial force Fₛₚ may be a six-dimensional vector representing forces and moments at a robot's end effectors located on a robot's multi-linkage body. It may be measured by a six axes force-torque sensor that may be mounted on the robot's joints or computed from joint torques via the transpose of the Jacobian. The spatial force may encompass contact forces and torques in three-dimensional space, providing a snapshot of how the robot is interacting mechanically with objects (e.g., pushing, lifting, or grasping forces).

Specifically, embodiments end effectors may be located on the specific physical configurations of the robot, such as a bimanual arm, a humanoid robot, a legged robot, manipulator, or any multi-linkage body implementing force-torque control logic.

In other non-limiting embodiments, the spatial force may be measured using strain gauge arrays, pressure sensors, vision-based force estimation, any combination thereof, or any measurement-providing device capable of enabling computation of forces and/or torques along six axes.

The embodiment may calculate spatial stiffness Kₓ by a minimally 6×1 matrix or a full 6×6 matrix characterizing how the end effector may resist displacement in each direction (translational and rotational). In impedance control, the robot may be programmed with a joint stiffness matrix K_{Q}. Furthermore, the joint stiffness matrix may be diagonal or full, depending on controller design. The spatial stiffness Kₓ may be the task-space stiffness as “felt” at the end effector and may be derived from joint-space stiffness using a Jacobian-based transformation.

In one embodiment, the following equation, Kₓ=J^{-T}K_{Q}J⁻¹, may give an approximate mapping of joint stiffness to Cartesian stiffness. Intuitively, Kₓ tells us how the end effector will respond to forces: a high value in a certain direction means the robot is very stiff (small deflection under force), whereas a low value means it's compliant (it will give way under force). The representation may use all 6 diagonal parameters or 36 independent parameters of Kₓ or a reduced parameterization (such as the principal diagonal or eigenvalues) depending on what the learning model can handle. The key point is that including stiffness may provide context on how rigid or compliant the robot is configured from the data at time t 604, which may influence the outcome of interactions (e.g., whether it gently approaches an object or firmly presses on it).

Similarly, spatial damping Dₓ may be determined by at least a 6×1 matrix or a full 6×6 matrix representing velocity-proportional damping at the end effector. Additionally, spatial damping may be a task-space impedance parameter. It may be derived from joint-space damping settings D_{Q} via an analogous Jacobian transformation Dₓ=J^{-T}D_{Q}J⁻¹. D_{Q} may determine how the robot dissipates energy and resists motion—high damping yields slow, controlled movements (overdamped), and low damping allows faster oscillatory responses. In physical interactions, damping may affect how the system responds to sudden impacts or motion changes—for instance, a critically damped system will smoothly come to rest without oscillation. By including Dₓ, the representation may account for the dynamic behavior settings of the robot.

Many manipulation tasks involve a robot gripper or hand mechanism applying force to objects. Gripper force F_{gripper} may be used to calculate the robot's force applied to objects. The Gripper force may be a scalar or small vector that indicates the current force or pressure being exerted by the gripper on an object or the motor current correlating to that force. As a nonlimiting example, if the robot is grasping an object, F_{gripper} reflects how hard it is squeezing. This information may be utilized for predicting events like object slip (a sudden drop in measured gripper force may indicate the object is falling) or object deformation/damage (too high a force could crush a fragile item). Thus, F_{gripper} may complement the wrist force Fₛₚ by focusing on the interaction at the gripper fingers.

The visual component may be raw images from a RGB camera, RGB-D camera, pre-processed visual features, or any device that can provide raw images to produce visual data. Embodiments may comprise a forward-facing camera observing the scene, including the objects to manipulate and the robot's end effector. A visual feature extractor network may process this image to extract pertinent features, such as object positions, shapes, and the like. In some embodiments, the visual data may be processed by a convolutional neural network or a Vision Transformer (ViT) 606 that produces an embedding of the image. The visual information provides context such as object identity, pose, and environmental layout—things that purely physical readings cannot discern. For instance, vision can tell the system where an object is and if there are obstacles, while force tells whether contact has occurred and how hard.

Vision data may still be obtained even if the camera or device capturing the vision data is momentarily occluded or operating under poor lighting conditions. In such cases, force and stiffness information may continue to guide the model. As a nonlimiting example, by enabling the system to detect or interact with an object through physical contact, even when the object is not visible. Conversely, if a force sensor exhibits slight drift or noise, the vision data may serve to anchor the model's estimation. This redundancy allows the system to maintain a reliable state estimate and prediction, even when one modality becomes less reliable or temporarily unavailable.

In a non-limiting embodiment, a fused learning representation 702 may be expressed in task space impedance that includes task space dynamics parameters but not limited to spatial force Fₛₚ, spatial stiffness Kₓ, spatial damping Dₓ, end effector pose Xₑₑ, gripper force F_{gripper}, and vision data.

In certain embodiments, the fused learning representation 702 may be expressed in joint-space impedance coordinates by aggregating the joint torques T_{Q}, the instantaneous geometric Jacobian J, joint-space stiffness K_{Q}, joint-space damping D_{Q}, end-effector pose Xₑₑ, gripper force F_{gripper}, together with vision features. This “raw” joint form may expose both kinematics and controller gains so that task-space impedance may be obtained internally—e.g., Kₓ=J^{-T}K_{Q}J⁻¹ and Dₓ=J^{-T}D_{Q}J⁻¹ or learned implicitly by the encoder-predictor, preserving configuration dependence of compliance. This joint-space variant may be interchangeable with the Cartesian stiffness/damping form.

Specifically, in humanoid embodiments a force-impedance aware learning representation—combining spatial force, stiffness, and damping with Jacobian mappings across all joints—may enable coordinated whole-body control by modulating compliance and force distribution across arms, torso, and legs during balance, locomotion, and manipulation.

As described above, individual sensor outputs may provide partial measurements. To address this, a fusion mechanism may be utilized to aggregate and reconcile the data into a unified latent representation of the system's state. Specifically, in one embodiment, the modalities (vision, spatial force, spatial stiffness/damping, gripper force) may combine into a unified latent representation of the system's state zₜ using Feature-wise Linear Modulation (FiLM) 610, wherein physical features (spatial force, stiffness and damping etc.) are encoded to produce scaling and offset parameters that modulate visual features, thereby conditioning the visual backbone on the robot's physical state.

However, other embodiments may utilize any suitable multi-modal fusion approach, including, without limitation: early fusion via concatenation with pooling of physical vectors and visual features; intermediate fusion using cross-attention or self-attention transformer architectures, in which force—stiffness tokens gate or modulate vision tokens (optionally extended with space—time attention mechanisms and/or recurrent components such as gated recurrent units (GRU), long short-term memory (LSTM), or recurrent state-space models (RSSM) to maintain temporal coherence); late fusion or decision-level fusion approaches, including Bayesian or evidential methods that probabilistically combine outputs from separate encoders with uncertainty propagation; encoder-decoder or shared-latent autoencoding schemes that merge modalities in a common representation space; graph neural network (GNN) architectures, wherein image patches are represented as nodes and force-stiffness signals are encoded as node or edge attributes to model spatial relations; tactile or force-to-image renderings that convert time-series contact signals into pseudo-images for compatibility with convolutional neural networks (CNN) or vision transformers (ViT) 606 MLP; multi-modal transformers that append physical tokens with positional and/or temporal embeddings to visual tokens; and hybrid projection techniques that map physical cues onto image coordinates proximate to the end-effector while maintaining a current latent state. Any of the above approaches, individually or in combination, may be employed to generate a fused learning representation 702 within the scope of this disclosure.

As noted above, the fusion may result in a unified latent representation of the system's state zₜ that is a compact encoding of the robot's state at time t, capturing both geometrical state (from vision) and interaction state (from forces/impedance). This zₜ may be viewed as a point in an abstract state-space tailored for the robot's task domain. The zₜ may be utilized by the predictive model 612 as the basis for forecasting the future. Specifically, the multi-modal fusion approach may be algorithm-agnostic and implementation-independent, the operation may be any technique that functionally combines visual inputs and physical interaction inputs into a joint latent.

By fusion, the unified latent representation may discover underlying physical properties. The model may infer object mass (from force responses), surface friction (from force patterns during sliding), and compliance (from stiffness changes), without being explicitly told. These emerge as the model attempts to reconcile multi-modal inputs over time. This physics awareness allows better generalization to new situations

Moving on, with the fused representation zₜ defined, the next component may be a predictive model 612 that learns the dynamics of zₜ over time. The predictive model 612 may be understood as an internal world model the robot learns—it tries to mimic how the real world evolves in response to actions and physics.

In one embodiment, the predictive model 612 follows a joint embedding prediction design. The architecture may be divided into an encoder neural network and a predictor network. Specifically, the encoder neural network may comprise a Sensorimotor Fusion Encoder 704 and the predictor network may comprise a Predictive Latent Dynamics Model (PLDM).

Sensorimotor Fusion Encoder (SFE) 704 may correspond to the fused learning representation 702 and outputs zₜ. For clarity, we can denote zₜ=SFE(FRₜ). Specifically, xₜ may represent the data collection of all sensor inputs at time t 604 (image, force, etc.). The encoder may encompass visual CNN/Transformer, the physical Multi Layer Perception (MLP) 608, and the fusion layer (eg. FiLM 610 layers or cross-attention transformers) that yield the unified latent representation. In training, the encoder may be applied both to the current state and the future state to produce target representations. In some training regimes, a target encoder (or momentum encoder) may be used to stabilize training (e.g., using an exponential moving average of the encoder weights, as done in BYOL or JEPA frameworks). But conceptually, the encoder ensures there is a consistent representation space where similarity (distance) may correspond to similarity in physical state—e.g., two similar latent vectors might indicate the robot and object are in similar configurations and contact conditions.

Next, a predictor network may take the unified latent representation (and possibly additional inputs like actions) and produce a future latent representation. The following equation may be written as \hat{z}=PLDM(zₜ, aₜ), for an action-conditioned model, or simply \hat{z}=PLDM(zₜ), for doing a pure observation prediction without explicit action input (as in passive observation learning). Specifically, the predictive network may be a Predictive Latent Dynamics Model (PLDM).

Furthermore, a predictor network may be implemented in various ways. In a simple form, it may be a feed-forward neural network (e.g., a multi-layer perception or small transformer) that directly outputs the future latent representation. In a more powerful form, it includes a recurrent state-space model (RSSM). As a nonlimiting example, the RSSM could have an internal hidden state hₜ that gets updated each time step: hₜ₊₁=G(hₜ, zₜ, aₜ) and then \hat{z}ₜ₊₁=W(hₜ₊₁), but also on its memory of prior states, where G is an RNN (like an LSTM) update function and W a linear decoder to output the future latent representation. The RSSM approach, used in some world model algorithms (e.g., Dreamer), may allow the predictor network to carry information over long horizons and cope with partial observability by not relying solely on zₜ to predict zₜ₊₁. Specifically, the RSSM may maintain a hidden state across time steps, the hidden state may be updated based on the current latent representation, such that the predictor network may model temporal dependencies over a sequence of states for long-horizon predictions.

In yet another embodiment, the predictor network may be realized as a Transformer operating over time, or a sequence-to-sequence model that reads a context of past states and predicts the next one—or several future states.

In additional embodiments, the PLDM may be realized as a multi-head-attention GRU (MHA-GRU) or transformer-based architecture (including hybrid attention-RSSM designs) to retain long-horizon temporal dependencies beyond a single-step Markov assumption. Such memory-augmented predictors may maintain persistent key-value or compressed state memories over tens to hundreds of steps, enabling the model to integrate weak but informative cues across time—e.g., inferring object mass from prolonged lift dynamics; detecting incipient slip from intermittent micro-fluctuations in force; modeling viscoelastic lag in cloth/film handling; capturing the torque ramp during screw-driving; accumulating contact micro-events for precise peg-in-hole insertion; or anticipating human handover release based on earlier load-sharing signals. Attention mechanisms may filter and retrieve relevant historical latents, while gated recurrence may enforce stability and compactness; together they may improve forecasting fidelity and planning utility over extended horizons within the same latent space.

Moving on, some embodiments may require training Specifically, the predictor network may match the actual future encoded state. If zₜ₊₁=SFE(FRₜ₊₁) is the encoded representation of the next time-step's sensor data, the training objective may include a term like L_{pred}=∥zₜ₊₁−\hat{z}∥ or another suitable distance measure in latent space. In some embodiments, a cosine similarity loss or L1 loss might be used instead, depending on what yields better representation learning. Furthermore, by minimizing this loss, the predictor network or PLDM may learn zₜ₊₁ to capture the dynamics of the fused representation. In effect, the predictor network or PLDM may internalize the physics: how does the next state relate to the current state? Because z includes force and stiffness information, the predictor network or PLDM may learn rules like “if force in downward direction is high while stiffness is low, expect a significant positional shift (object moves) by next step” or “if a high torque is sensed and the vision shows a blockage, expect minimal change (since something is preventing motion)”. These are not coded explicitly but may be learned from data that is collected from interaction.

To train various embodiments, a user may collect sequences of robot interaction data. As a nonlimiting example, the robot may be ran through a variety of manipulation tasks (grasping objects, pushing them, etc.) in simulation and/or real experiments, recording at each time step the image, the measured forces, the commanded stiffness/damping, gripper force, and the action taken (if any). Each sequence may be treated as a training trajectory. The encoder SFE and predictor network—or PLDM—may be optimized together to minimize the sum of the prediction loss L_{pred}, which ensures accuracy of predicting future latent representations.

Other embodiment may include other loss terms. As a nonlimiting example, a reconstruction loss may be included if zₜ₊₁ is decoded back to some sensor space. Additionally, although the embodiment may focus on the future latent representations, a user may include an image decoder to visualize predicted future frames as an auxiliary task. Another embodiment may include a reward prediction loss if used in an RL context, which may predict a future reward or task success signal from z.

In one embodiment aligned with JEPA principles, the model may be trained by masking out the future steps' data and asking the predictor network to fill it in latent space. Concretely, the model may be shown a context window of data and asked to predict the future latent representation at a later time t+n (with intermediate time steps masked). The predictor network then may attempt to produce an embedding that matches the target encoder's output for that time t+n. This context-prediction training may force the latent to encode information relevant for prediction. As a nonlimiting example, if to predict 1 second later the robot's gripper may slip, the latent must encode the current object's stability and weight (which could be inferred from current force and vision). If to predict a collision, the latent must encode that the robot is moving towards a wall.

An embodiment may undergo action conditioning. Specifically, if a robot's action influences the future, incorporating the action aₜ into the predictor network may greatly improve accuracy. As a nonlimiting example, if the robot decides to suddenly lift its arm at time t, the forces at t+1 will increase (due to gravity on the object), but if it stays still, forces may decrease as transients settle. The predictor network may only know this if it is given aₜ. Therefore, in some embodiments, the robot's action command or control input may be included as part of the predictor network's input. The action may include but is not limited to the joint torque, end effector spatial force, spatial impedance parameters, joint impedance parameters, or gripper force.

Mathematically, the action conditioning may be noted as \hat{z}=PLDM(zₜ, aₜ). Training may involve sampling action-conditioned transitions. If passive video data (with no action info) is also used (as in some large video pre-training), the model may be trained in two phases: first on passive observations (with just PLDM(zₜ) for generic physics understanding), and second on robot data with action inputs fine-tuning PLDM(zₜ, aₜ).

Embodiments may include a temporal smoothness regularization term in the model's training objective. Specifically, real physical states evolve smoothly due to inertia and continuous time dynamics. If a learning model were free to do so, it might try to “cheat” by jumping in latent space to better fit next-step predictions, especially if the latent is high-dimensional. Such jumping could yield a model that, for example, predicts a completely different future latent representations that coincidentally map to the correct next observation but is not consistent with a smooth path. That would be undesirable for downstream planning, as it implies non-physical behavior internally.

To mitigate this, embodiments may utilize a finite difference term and a temporal smoothness regularization term k objective function 708:

$${{L}_{rate} = λ \frac{1}{T - 1} {\sum }_{t = 2}^{T} {‖ {z}_{t + 1} - {z}_{t} ‖}_{p} ( Finite Difference Term , L 1 norm ) ; {L}_{rate} = λ {\sum }_{t} ‖ {∇}_{t} {z}_{t} ) ‖}_{q}^{2} ( Regularization Term , L 2 norm ) .$$

This may encourage zₜ₊₁−zₜ to be small. In other words, the solution may be biased toward slowly varying features.

In an embodiment, zₜ may comprise learned features rather than hand-crafted ones and therefore may not be limited to slowly varying dynamics; as such, may not be required that zₜ exhibit slowness. The smoothness loss may tell the neural network: “all else equal, prefer to make zₜ₊₁ close to zₜ.” The predictor network may balance this with the need to accurately predict changes (from the prediction loss). The predictor network may only create a large difference if the data demands it (i.e., if the actual next state is truly far in latent space). If the actual change is small, the predictor network may keep the change small to both fit the data and satisfy smoothness.

To illustrate the physical interpretation, the following is a non-limiting example. This regularization term has an intuitive physical meaning: it can be understood as penalizing high acceleration or jerk in the latent state. For example, consider a ball bouncing-without regularization, a model might predict that the ball's latent state “teleports” when it contacts the ground, as a naive vision-based model may fail to capture the smooth deceleration and rebound.

In contrast, when a smoothness cost is applied, the model is more likely to represent the bounce using intermediate latent states that interpolate the motion, thereby reflecting continuous deceleration and reversal of velocity. In robotic manipulation, a similar principle applies, for instance, when a robot's gripper picks up an object, the applied forces do not change instantaneously but may increase smoothly as the object's weight is loaded. Accordingly, the latent difference zₜ₊₁−zₜ, particularly for force-related components, is expected to remain moderate if the model is trained with smoothness constraints.

Some embodiments may utilize a method to train a latent dynamics model with smoothness constraints. First, a sequence of state representations obtained from multi-modal observations of a system may be provided to the predictive model 612. Specifically, each state representation zₜ may be an encoding of sensor data at time t 604. Next, the predictive model 612 may learn a PLDM predictive function PLDM such that PLDM (zₜ)≈z_(t+1) for the sequence, by minimizing a loss that may include a prediction error term measuring discrepancy between PLDMzₜ) and z(ₜ+1) and a regularization term penalizing PLDM(zₜ)−zₜ. This may result in biasing the learned predictive function toward generating representations PLDM(zₜ) that change gradually relative to zₜ. Additionally, the robotic system's sensor data and state representations may be multi-modal or unimodal, and the smoothness constraint may enhance the realism and stability of the learned dynamics in the latent space.

Some embodiments may utilize formulation variants. One embodiment may utilize an L1 norm (finite difference term) for robustness to outliers or even incorporate second-order differences (L2 norm) to directly penalize jerk (change in acceleration).

In some embodiments, a training objective may combine the prediction loss with the temporal smoothness regularizer Lₜₒₜₐₗ=L_{pred}+Lᵣₐₜₑ where the smoothness term uses a derivative term of finite term with L2 regularization on latent-rate changes:

$${{L}_{rate} = λ {\sum }_{t} ‖ {∇}_{t} {z}_{t} ) ‖}_{q}^{2} .$$

In the preceding equation, may λ>0 set the relative weight of the smoothness prior. This choice may encourage physically continuous evolution in latent space while still permitting large, data-justified transitions (e.g., contact impulses). The formulation may apply identically for both explicit action-conditioning \hat{z}ₜ₊₁=PLDM(zₜ, aₜ) and latent-as-action \hat{z}ₜ₊₁=PLDM(zₜ) regimes.

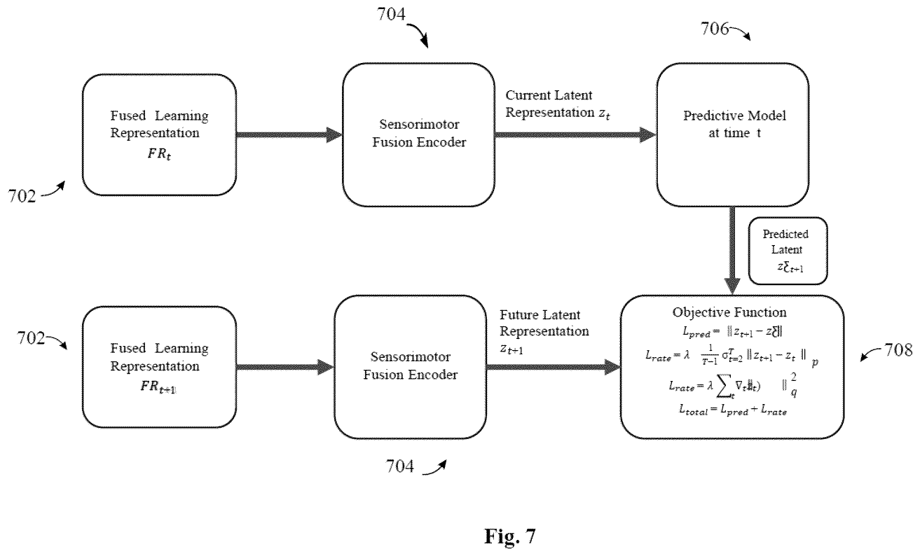

FIG. 7 illustrates a flowchart of a non-limiting example training method for the predictive model 612. Specifically, FIG. 7 begins with the fused learning representation 702 being provided to a Sensorimotor Fusion Encoder 704, which may generate either a current latent representation or a future latent representation. If the Sensorimotor Fusion Encoder 704 produces a current latent representation, the current latent may be provided to the predictive model at time t 706 to produce a predicted latent representation, which is then passed through the objective function 708. If the Sensorimotor Fusion Encoder 704 produces a future latent representation, the future latent representation may be provided directly to the objective function 708.

In one or more non-limiting embodiments, a robotic system (the “system”) may include a robotic manipulator having a plurality of joints providing multiple degrees of freedom, an end effector configured to interact with physical objects in an environment, and a set of sensors providing multi-modal feedback related to forces, contact events, and visual observations. The system may be configured to perceive, learn, and predict its own dynamics by integrating information across these multiple sensing modalities.

In another non-limiting embodiment, the system may include other physical configurations, in place of the manipulator, such as a bimanual arm, a humanoid robot, a legged robot, or any multi-linkage body implementing force-torque control logic.

The multi-modal feedback may include but is not limited to visual data from a device, spatial force of a robot's multi-linkage body, spatial stiffness, spatial damping, and gripper force.

The system may include one or more force or torque sensors positioned at or proximate to the end effector for measuring interaction forces between the multi-linkage body and an external object. In certain embodiments, a six-axis force-torque sensor may be employed to measure forces and torques along orthogonal spatial axes.

The system may further include one or more vision sensors, such as RGB cameras, depth sensors, stereo cameras, or structured-light sensors, oriented to capture images or depth information of the multi-linkage body, the workspace, and objects therein. The vision data may include information relating to object positions, contacts, and surface properties, which can complement or substitute for force information under certain conditions.

A computing device may be operatively coupled to the sensors and to actuators that drive the joints of the multi-linkage body. The computing device may implement a neural network-based predictive model 612 comprising an encoder network and a predictor network, which together form a predictor model or similar architecture.

In certain embodiments, the encoder network may receive multi-modal sensor inputs, such as force vectors, torque measurements, tactile readings, and image data, and may generate a latent state representation that compactly encodes the current condition of the multi-linkage body and its environment.

Specifically, one or more sensors may include a device providing video or images of the environment, a six-axis force-torque sensor at the end-effector measuring spatial forces, encoders or sensing elements for determining joint stiffness, and damping and gripper force, such that all these sensor outputs are provided as inputs to the encoder network.

A predictor network may then receive the current latent representation and output a predicted latent representation corresponding to a future time step. The predicted latent state may capture expected physical evolution, such as movement trajectories, contact transitions, or changes in applied force.

The computing device may implement a training module configured to adjust the parameters of the encoder network and predictor network using self-supervised learning. In one embodiment, the module minimizes a loss function comprising one or more terms that encourage accurate temporal prediction of the latent representations.

In non-limiting embodiments that comprise of manipulators or humanoids, one or more computing devices may be configured to share the training module or force feedback between the manipulators or humanoids to coordinate a collaborative manipulation task.

The loss function may further include a temporal smoothness term that penalizes large differences between latent representations at consecutive time steps, thereby promoting continuity in the learned latent dynamics. Such smoothness regularization may encourage the model to represent physical processes, such as contact, impact, or motion, in a manner consistent with real-world temporal behavior. Specifically, the temporal smoothness term may comprise of the temporal smoothness regularization term.

Once trained, the predictive model 612 may serve as a world model within a control or planning loop. The world model may simulate possible future states or outcomes based on hypothetical or planned actions, enabling the robotic system to select or refine actions that are expected to achieve a desired task objective.

As a nonlimiting example, during object manipulation, the model may predict how changes in gripper force or joint motion affect contact stability or object motion, allowing the controller to adapt actions in real time. This predictive capability improves the system's understanding of physical interactions, resulting in more stable, adaptive, and efficient manipulation behavior.

The disclosed approach may enable various manipulation applications including robotic assembly (peg-in-hole insertion, circuit board connectors), human-robot interaction (tray holding with adaptive compliance), grasping and tool use (screwdriver operations with progressive stiffening), and multi-robot collaboration (coordinated carrying of fragile objects with force balancing). The learning representation may enable AI agents to recognize force patterns, adjust impedance characteristics, and coordinate manipulation strategies across diverse task scenarios.

1. A method of learning physical interactions in robotic manipulation, comprising:
formulating a learning representation that includes a spatial force of a robotic manipulator, a spatial stiffness, and a spatial damping of the manipulator;
deriving the spatial stiffness and the spatial damping from joint-space stiffness and damping parameters using a Jacobian-based transformation; and
providing the learning representation as an input state to an artificial intelligence learning algorithm, wherein the artificial intelligence learning algorithm uses the learning representation to learn a control policy for manipulating objects or regulating contact forces.

2. The method of claim 1, wherein the learning representation is provided in a first form comprising a six-dimensional spatial force vector including forces and moments, a spatial stiffness matrix, a spatial damping matrix, an end effector pose, a gripper force measurement, and vision sensor data.

3. The method of claim 1, wherein the learning representation is provided in a second form comprising N-degrees of freedom joint torque, a Jacobian matrix of the robotic manipulator, a joint-space stiffness matrix, a joint-space damping matrix, joint angles, a gripper force measurement, and vision sensor data.

4. The method of claim 1, wherein the spatial stiffness Kₓ is defined as Dₓ=J(q)^{-T}D_{Q}J(q)⁻¹ and the spatial damping Dₓ is defined as Kₓ=J(q)^{-T}K_{Q}J(q)⁻¹, where J is a Jacobian matrix of the robotic manipulator, K_{Q} is a joint-space stiffness matrix, and D_{Q} is a joint-space damping matrix.

5. The method of claim 2, wherein the vision sensor data comprises RGB images captured by cameras observing a robotic manipulator's workspace.

6. The method of claim 5, wherein the vision sensor data further comprises depth maps providing three-dimensional spatial information about objects in the robotic manipulator's workspace.

7. The method of claim 2, further comprising controlling the robotic manipulator using an impedance-based control law that incorporates the learned control policy, wherein a commanded end-effector force is computed as a sum of a guidance force provided by the artificial intelligence learning algorithm, a reactive force term from the spatial stiffness matrix multiplied by an end-effector position error, a reactive force term from the spatial damping matrix multiplied by an end-effector velocity error, and compensation forces for gravity and Coriolis effects, such that the guidance force is generated by the artificial intelligence learning algorithm based on learned manipulation strategies for specific task contexts, wherein the learned control policy outputs a modification to a desired trajectory or pose based on the learning representation, such that a robotic manipulator's controller adjusts an impedance or motion to regulate contact forces.

8. The method of claim 1, wherein the robotic manipulator comprises one or more series elastic actuators at its joints, each series elastic actuator having an elastic element with flexible spokes and a sensor for measuring deflection of the elastic element, and wherein joint torque values derived from the measured deflection are included in the learning representation as part of the spatial force or as joint-level force feedback.

9. A robotic system, comprising:
a robotic manipulator with multiple degrees of freedom;
one or more sensors configured to measure forces at an end effector of the robotic manipulator and to capture visual data of a manipulator's workspace; and
a control unit comprising a processor configured to execute an artificial intelligence agent, wherein the control unit is programmed to formulate a learning representation including spatial force, spatial stiffness, and spatial damping information from the robotic manipulator and to adjust control commands to the robotic manipulator based on said representation, such that the system learns to manipulate objects through physical interaction by adapting stiffness, damping, and applied forces in response to sensor inputs.

10. The robotic system of claim 9, wherein the one or more sensors comprises any of a six-axis force-torque sensor mounted at a wrist of the robotic manipulator for measuring the spatial force and a gripper force sensor configured to measure forces applied by an end effector gripper of the robotic manipulator.

11. The robotic system of claim 9, wherein the control unit is programmed to derive the spatial stiffness and spatial damping from joint-space stiffness and damping parameters using Jacobian-based transformations, the Jacobian-based transformations comprising the use of a Jacobian transpose or pseudoinverse for mapping between joint space and task space.

12. The robotic system of claim 11, wherein the spatial stiffness Kₓ is computed as Kₓ=J(q)^{-T}K_{Q}J(q)⁻¹ and the spatial damping Dₓ is computed as Dₓ=J(q)^{-T}D_{Q}J(q)⁻¹, where J is a Jacobian matrix of the robotic manipulator, K_{Q} is a joint-space stiffness matrix, and D_{Q} is a joint-space damping matrix.

13. The robotic system of claim 9, wherein the artificial intelligence agent is configured to execute a reinforcement learning algorithm that uses the learning representation as a state input and generates actions that modify impedance parameters of the robotic manipulator.

14. The robotic system of claim 9, wherein the one or more sensors corresponds to one or more actuators, and wherein the processor controls the one or more actuators based on torque measurements from the one or more sensors.

15. The robotic system of claim 14, wherein the artificial intelligence agent comprises a plurality of artificial intelligence agents, wherein each artificial intelligence agent of the plurality of artificial intelligence agents is hosted by an individual processor located in each robotic actuator of the one or more robotic actuators, and wherein each artificial intelligence agent of the plurality of artificial intelligence agents collects a respective data set.

16. The robotic system of claim 15, wherein each artificial intelligence agent of the plurality of artificial intelligence agents are in communication with a central processor, wherein each artificial intelligence agent of the plurality of artificial intelligence agents transmit their respective data sets to the central processor.

17. A method of controlling a robotic manipulator using impedance-based learning, comprising:
generating a spatial force field via a learning model that processes impedance-based learning representation data including spatial force vectors, spatial stiffness matrices, and spatial damping matrices;
constructing a Jacobian representation of a force vector using the spatial force field and spatial force vector;
training an artificial intelligence agent based on the Jacobian representation using reinforcement learning, supervised learning, or imitation learning; and
continuously updating the Jacobian representation based on real-time inputs from the robotic manipulator.

18. The method of claim 17, wherein the impedance-based learning representation data comprises a spatial force vector, a spatial stiffness matrix, a spatial damping matrix, an end effector pose, a gripper force measurement, and vision sensor data.

19. The method of claim 18, wherein the vision sensor data comprises RGB images and depth maps captured by cameras observing a robotic manipulator's workspace.

20. The method of claim 19, wherein the artificial intelligence agent is trained using a reinforcement learning algorithm that receives the Jacobian representation as a state input and generates actions that modify spatial stiffness and damping parameters of the robotic manipulator, and wherein initial data sets are derived from human demonstrations that include force sensor data from robotic actuation joints converted into Jacobian matrices of stiffness and damping and denoted as high rewards.
